(19) United States
(12) Patent Application Publication
(10) Pub. No.: US 2022/0324772 A1
(43) Pub. Date: Oct. 13, 2022

(54) PARTICULATE COMPOSITIONS AND METHODS OF USE

(71) Applicant: Innovative Hort Solutions, LLC, Marysville, OH (US)

(72) Inventor: Harvey M. Goertz, Marysville, OH (US)

(73) Assignee: Innovative Hort Solutions, LLC, Marysville, OH (US)

(21) Appl. No.: 17/721,452

(22) Filed: Apr. 15, 2022

Related U.S. Application Data
(63) Continuation of application No. 16/330,308, filed on Mar. 4, 2019, now abandoned.
(60) Provisional application No. 62/383,325, filed on Sep. 2, 2016.

(51) Int. Cl. C05G 5/30; C05C 3/00; C05C 9/00; C05C 9/02; C05D 3/00

(52) U.S. Cl. CPC C05G 5/30; C05G 5/38; C05C 3/005; C05C 9/005; C05C 9/02; C05D 3/00

(57) ABSTRACT

Particulate compositions including cores, binders, and powders are provided. Also provided are methods for producing particulate compositions, and methods for using particulate compositions.

### CROSS-REFERENCE TO RELATED APPLICATIONS

This application is a continuation of U.S. Nonprovisional patent application Ser. No. 16/330,308, filed on Mar. 4, 2019, now abandoned, which is a National Stage Entry of International Application No. PCT/US2017/049988, filed on Sep. 2, 2017, which claims priority from U.S. Provisional Patent Application No. 62/383,325, filed on Sep. 2, 2016, each of which is incorporated herein by reference in its entirety.

### BACKGROUND

Agricultural and horticultural compositions are typically applied to areas as liquids, granules, or powders, often with the objective of achieving uniform distribution.

Liquid compositions are generally water-based and may be applied by spray application, knife injection, via crop irrigation systems, and the like. Although liquid applications afford excellent distribution, the required water carrier may be costly to ship and store. Additionally, liquid blends often suffer from incompatibility issues, which can result in coagulation, phase separation, corrosion, and the like.

Compared to liquid compositions, granular compositions may be less costly to ship and store. Granular compositions may be more flexible in terms of blend compatibility compared to liquid compositions. Although granular blends, also referred to as heterogeneous granular compositions, may be used, homogeneous granular compositions may be preferred for reasons of consistency and uniform delivery. For effective delivery of a granular composition, it is desirable that the particle distribution density, e.g., in particles per square foot, is sufficiently high to provide each root system with effective and uniform access to the nutrients within the granular composition.

The present application appreciates that producing and using agricultural and horticultural compositions may be a challenging endeavor.

### SUMMARY

In one embodiment, a flowable, dust-mitigated particulate composition is provided. The particulate composition may include a plurality of particles. Each particle of the plurality of particles may include a core. Each particle of the plurality of particles may include a one or more coating layers disposed about the core. Each of the one or more coating layers may include one or more of a thermo-softening binder and a powder. The powder may be at least partly adhered to the core via the thermo-softening binder.

In one embodiment, a method for producing a flowable, dust-mitigated particulate composition is provided. The method may include providing a plurality of cores. The method may include heating a thermo-softening binder to a temperature effective to liquefy the thermo-softening binder to provide a liquefied thermo-softening binder. The method may include forming one or more coating layers disposed concentrically about each core. Forming each coating layer may include contacting each core with the liquefied thermo-softening binder to dispose a binder layer about each core. Forming each coating layer may include contacting each binder layer with a powder to provide a powder-binder-layer disposed about each core. Forming each coating layer may include cooling the powder-binder-layer to solidify the liquefied thermo-softening binder effective to bind the powder to the binder layer to form each coating layer. The method may thereby form the flowable, dust-mitigated particulate composition as a plurality of the cores comprising the one or more coating layers disposed about each core.

In one embodiment, a method for nutrient uptake by a plant rooting system is provided. The method may include providing a flowable, dust-mitigated particulate composition. The particulate composition may include a plurality of particles. Each particle may include a core and one or more coating layers disposed about the core. Each of the one or more coating layers may include a thermo-softening binder and a powder. The powder may be at least partly adhered to the core via the thermo-softening binder. The method may include providing a soil growing medium. The soil growing medium may include the plant rooting system. The soil growing medium may be capable of sustaining the plant rooting system. The method may include contacting the particulate composition to the soil growing medium at a particle distribution density effective to facilitate nutrient uptake by the plant rooting system in the soil growing medium.

### BRIEF DESCRIPTION OF THE DRAWINGS

The accompanying figures, which are incorporated in and constitute a part of the specification, illustrate example compositions, methods, and kits, and are used merely to illustrate example embodiments.

FIG. 1 illustrates an example embodiment of a particulate composition.

FIG. 2 illustrates an example embodiment of a particulate composition.

FIG. 3 illustrates an example method for producing a particulate composition.

FIG. 4 illustrates an example method for nutrient uptake by a plant rooting system using a particulate composition.

FIG. 5A is a table illustrating distribution rates at a particulate distribution density of 20 for particulate compositions with a density of 0.67 g/mL and characterized by various SGN values.

FIG. 5B is a table illustrating distribution rates at a particulate distribution density of 20 for particulate compositions with a density of 1.0 g/mL and characterized by various SGN values.

FIG. 5C is a table illustrating distribution rates at a particulate distribution density of 20 for particulate compositions with a density of 2.0 g/mL and characterized by various SGN values.

### DETAILED DESCRIPTION

Described herein is a flowable, dust-mitigated particulate composition, and methods of making and using the composition. The flowable, dust-mitigated particulate composition provides effective, dust-mitigated storage and delivery of compounds or agents in powder form, e.g. nutrients, agricultural agents, and the like. Compared to liquid phase delivery, the flowable, dust-mitigated particulate composition may be less costly to ship and store, more stable over time, and/or more compatible with storage and delivery equipment. Further, the flowable, dust-mitigated particulate composition may lead to substantially less dust than other flowable particulate compositions. The flowable, dust-mitigated particulate composition may be useful for delivery of the powdered compounds or agents to plants, animals, microorganisms, and the like.

In various embodiments, a flowable, dust-mitigated particulate composition is provided. The particulate composition may include a plurality of particles. Each particle of the plurality of particles may include a core. Each particle of the plurality of particles may include a one or more coating layers disposed about the core. Each of the one or more coating layers may include one or more of a thermo-softening binder and a powder. The powder may be at least partly adhered to the core via the thermo-softening binder.

As used herein, “about the core” means contacting a coating layer to the core and/or to one or more previous coating layers, for example, “about the core” may mean one or more of: a first layer may contact the core and a second layer may contact the first layer; a first layer may contact at least part of the core; a second layer may contact the first layer; a second layer may contact at least part of the core; and the like. In some embodiments, “about the core” may mean a concentric layer.

In some embodiments, the particulate composition may be substantially dust-free. As used herein, “dust” means particles capable of passing through a No. 70 US sieve. Dust comprised or produced by a particulate composition may be characterized as a wt % of the total particulate composition released in the form of dust when the particulate composition is dropped from a height of 2 meters or shaken in a canister for a period of less than 3 min. In some embodiments, the “substantially dust free” composition may release as dust material a wt % of the total composition of less than one or more of about 1, 0.9, 0.8, 0.7, 0.6, 0.5, 0.4, 0.3, 0.2, 0.1, 0.09, 0.08, 0.07, 0.06, 0.05, 0.04, 0.03, 0.02, or 0.01, for example, less than about 1 wt %, or less than about 0.1 wt %.

In many embodiments, the plurality of particles may be characterized by a Size Guide Number (SGN). As used herein, the SGN is calculated by the sieve opening in mm that retains or passes 50 wt % of a sample of particles, multiplied by 100. The plurality of particles may be characterized by a SGN of about one or more of: 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 210, 220, 230, 240, 250, 275, 300, 325, 350, 375, 400, 425, 450, 475, 500, 550, 600,750, 1000, 1250, 1500, 1750, 2000, 2500, and 3000. The plurality of particles may be characterized by a SGN between any of the preceding values, for example, between about 75 and about 85, between about 60 and about 100, between about 75 and about 350, between about 75 and about 100, about 125 and about 150, about 150 and about 250, and the like. In some embodiments, the plurality of particles may be characterized by a SGN greater than about 80. In some embodiments, the plurality of particles may be characterized by a SGN greater than about 150. In some embodiments, the plurality of particles may be characterized by a SGN of between about 250 and about 320.

In several embodiments, the plurality of particles may be characterized by Uniformity Index (UI). The UI is a characterization that represents the consistency of the diameter of granules within a lot of fertilizer. For example, a UI of 50 may include a range of variable-sized particles with the average smallest particle being one-half the size of the average largest particle, while a UI of 33 may include a range of variable-sized particles with the average smallest particle being one-third the size of the average largest particle. As used herein, the UI of a sample of particles is determined by the sieve opening in mm that retains 95 wt % (passes 5 wt %) of the sample of particles divided by the size of the sieve opening in mm that retains 10 wt % (or passes 90 wt %) of the sample of particles. The resulting fraction is multiplied by 100 to arrive at the UI. The plurality of particles may be characterized by a UI of about one or more of: 30, 35, 40, 45, 50, 55, 60, 65, 70, 75, 80, 85, 90, 95, and 100, e.g., a UI of greater than about 30 or greater than about 45, or a range between any of the preceding values, for example, between about 35 and about 60, between about 50 and about 55, and the like.

In several embodiments the plurality of particles may be characterized by a SGN of about one or more of: 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 210, 220, 230, 240, 250, 275, 300, 325, 350, 375, 400, 425, 450, 475, 500, 550, 600, 750, 1000, 1250, 1500, 1750, 2000, 2500, and 3000; and a UI of about one or more of: 30, 35, 40, 45, 50, 55, 60, 65, 70, 75, 80, 85, 90, 95, and 100. The plurality of particles may be characterized by a SGN and UI between any of the preceding values, for example, an SGN of between about 80 and about 150, and an UI of between about 45 and about 60, and the like. The plurality of particles may be characterized by an SGN greater than about 80 and an UI greater than about 30. The plurality of particles may be characterized by an SGN greater than about 80 and an UI greater than about 45. The plurality of particles may be characterized by an SGN of about 80 and an UI of about 50.

In many embodiments, the core may include one or more of: a nutrient, a seed, an agricultural agent, and a carrier.

Nutrients may be in the form of one or more of a primary nutrient, a secondary nutrient, and a micronutrient. The nutrient may be configured for absorption/ingestion/digestion by a plant, microorganism, and/or an animal, e.g., configured as an agricultural nutrient or an animal nutrient. The agricultural nutrient may provide nutrients to one or more of: corn, soybean, wheat, grass, hay, clover, cotton, sorghum, barley, canola, bean, sunflower, oat, pea, lentil, rye, rice, peanut, sugar beet, a vegetable, a microorganism, a fungus (e.g., mushroom), and the like. The micronutrient may include an animal micronutrient. The animal micronutrient may provide nutrients to a subject of, e.g., one or more of: mammals, fish, cattle, pigs, sheep, goats, horses, chickens, humans, and the like.

For example, a plant nutrient may include one or more of: a primary nutrient, a secondary nutrient, and a micronutrient. An animal nutrient may include, for example, one or more of: a feed, a vitamin, a mineral, and a nutritional supplement.

Nutrients may include bioavailable forms of various elements, for example, one or more elements of: boron, chlorine, fluorine, iodine, copper, iron, manganese, molybdenum, nickel, zinc, cobalt, magnesium, chromium, calcium, sodium, sulfur, nitrogen, phosphorus, potassium, selenium, and silicon. Such elements may be provided in bioavailable form as, for example: minerals or elemental form, where such form is commonly used in nutrients, such as elemental sulfur as an agricultural nutrient; organic compounds e.g urea and urea derivatives, inorganic salts or complexes, e.g., phosphate, oxide, carbonate, sulfate, chloride, and nitrate salts; organic-inorganic complexes, such as metals chelated by organic ligands or metallic salts of organic ions; organic salts; organic compounds; combinations thereof; and the like. As used herein, “chelate” may refer to any known chelating substances. For example, a chelate may include any of the following organic ligands: ethylenediaminetetraacetic acid (EDTA); ethylenediamine; ethylenediamine-di-(o-hydroxyphenylacetic acid) (EDDHA); ethylenediamine-di-(2-hydroxy-p-methylphenylacetic acid) (EDDHMA); ethylenediamine (2-hydroxy-5-sulfophenylacetic acid) (EDDHSA); ethylenediamine-di-(5-carboxy-2-hydroxyphenylacetic acid) (EDDCHA); ethanoldiglycinic acid (EDG); (2-hydroxyethyl)ethylenediaminetriacetic acid (HEDTA); diethylenetriaminepentaacetic acid (DPTA); citric acid; glucoheptonate; glutamic acid, N,N-diacetic acid (GLDA); glucoheptonic acid; porphyrins; dimercaprol; nitrilotriacetic acid (NTA); propylenediamine tetraacetic acid (PDTA); or lignonsulfonate (LSA). For example, a copper chelate may include copper EDTA, copper DPTA, and the like.

In some embodiments, the nutrient may include one or more primary nutrients. For example, the primary nutrient may include one or more of: nitrogen, phosphorus, and potassium.

Nitrogen may be, e.g., in the form of one or more of: urea, a urea-formaldehyde resin, an isobutylidene diurea, a methylene urea, ammonium nitrate, ammonium sulfate, ammonium sulfate nitrate double salt, mono-ammonium phosphate, di-ammonium phosphate, potassium nitrate, and the like. As used herein, methylene ureas may refer to Mannich-type products of urea and an aldehyde, such as formaldehyde. For example, a methylene urea may include NH₂C(O)NH[CH₂NHC(O)NH]ₙH, where n is any integer greater than 0, and mixtures thereof. For example, the methylene urea may include NUTRALENE® or NITROFORM® (Koch Turf and Ornamental, Wichita Kans.). As used herein, urea-formaldehyde resins, such as ureaform (e.g., SIRFLOR®, Sadepan Chimica, Mantova, Italy), may refer to non-linear Mannich-type products of urea and formaldehyde. For example, condensation of urea and formaldehyde may produce resins including triazinanes, linear (above) and branched methylene urea groups. As used herein, isobutylidene diureas (IBDU) may refer to Mannich-type products of urea and isobutyraldehyde, e.g., NH₂C(O)NH[CH[CH(CH₃)₂]NHC(O)NH]ₘH, where m is any integer greater than 0, for example m=2, and mixtures thereof. As used herein, the term methylene urea may include any Mannich-type products resulting from condensation of urea and an aldehyde or a ketone and subsequent urea addition to the resulting imine. Phosphorus, may be, e.g., in the form of one or more of: mono-ammonium phosphate, di-ammonium phosphate, single superphosphate, triple superphosphate, calcium phosphate, mono-potassium phosphate, potassium tripolyphosphate, tripotassium phosphate, and the like. Potassium, may be, for example, in the form of one or more of: potassium chloride, potassium sulfate, potassium nitrate, and the like. Such primary nutrients may be provided in the form of a premade fertilizer, which may include all primary nutrients within each particle such as a Complex Fertilizer as defined by EU Fertilizer Regulations; e.g., a potassium/sulfur (KS) fertilizer, a nitrogen/phosphorus/potassium/sulfur (NPKS) fertilizer, and the like. A NPKS fertilizer may include one or more of: nitrogen, phosphorus, potassium, and sulfur, for example, nitrogen and sulfur, for example, nitrogen, phosphorus, and potassium, and the like. A NPKS or KS fertilizer may be a Complex Fertilizer, The primary nutrient may be provided in plant-available-form or as a coated, controlled-release form.

In several embodiments, the nutrient may include one or more secondary nutrients that provide, e.g., one or more of: magnesium, sulfur, and calcium.

Magnesium may be, for example, in the form of one or more of: magnesium sulfate, magnesium chloride, magnesium oxide, magnesium carbonate, and the like. Calcium may be, for example, in the form of one or more of: calcium sulfate, calcium chloride, calcium carbonate, calcium silicate, calcium phosphate, and the like. Sulfur may be, for example, in the form of one or more of: elemental sulfur or a sulfate, e.g., any sulfate described herein, such as ammonium sulfate, potassium sulfate, magnesium sulfate, calcium sulfate, and the like.

In several embodiments, the nutrient may include one or more micronutrients. Each micronutrient may include one or more of: boron, copper, iron, manganese, molybdenum, nickel, zinc, and the like. Boron may be, for example, in the form of one or more of boric acid, sodium borate, sodium tetraborate, sodium octaborate, sodium metaborate, potassium borate, potassium tetraborate, potassium octaborate, potassium metaborate, and the like. Copper may be, for example, in the form of one or more of copper chelate, copper chloride, copper oxide, copper sulfate, and the like. Iron may be, for example, in the form of one or more of iron chelate, iron chloride, iron oxide, iron sulfate, and the like. Manganese may be, for example, in the form of one or more of manganese chelate, manganese chloride, manganese oxide, manganese sulfate, and the like. Molybdenum may be, for example, in the form of one or more of ammonium molybdate, sodium molybdate, and the like. Nickel may be, for example, in the form of one or more of nickel chelate, nickel sulfate, and the like. Zinc may be, for example, in the form of one or more of zinc chelate, zinc chloride, zinc oxide, zinc sulfate, and the like.

The preceding nutrients are commercially available in suitable forms and combinations from various sources, for example, the WOLF TRAX® series of nutrients (Compass Minerals Manitoba Inc., Winnipeg, MB, Canada). For example, WOLF TRAX® Boron may include boric acid, sodium borate, and potassium tetraborate; WOLF TRAX® Copper may include copper sulfate, copper oxide, copper chloride; WOLF TRAX® Iron may include iron sulfate and iron oxide; WOLF TRAX® Magnesium may include magnesium sulfate, magnesium carbonate, and magnesium oxide; WOLF TRAX® Manganese may include manganese chloride and manganese sulfate; WOLF TRAX® Zinc may include zinc sulfate and zinc oxide; and the like.

In various embodiments, the flowable, dust-mitigated particulate composition may include one or more agricultural agents. Such agricultural agents may include, for example: a humate, such as a humic acid, a fulvic acid or a humin; a biostimulant, such as a plant extract, an amino acid, a polysaccharide, a polypeptide and others such as those offered by Valagro SpA, Chieti Italy; an enzyme; a vitamin; a hormone; an inoculant; a soluble polymer; a signaling chemical; a phosphite; a nutrient synergist, such as those offered by Verdesian Life Sciences, Cary N.C.; a mycorrhizal fungus; a bacterium; a probiotic; or a plant control chemical or biocontrol agent, such as a growth regulator, a herbicide, an insecticide, a fungicide, and the like.

In various embodiments, the flowable, dust-mitigated particulate composition may include one or more carriers. The carrier may include, for example, waste plant material, such as pollen grains, ground husks, shells, cores, skins, stalks, and the like. The carrier may include, for example, inert minerals, such as limestone, silica, clay, alumina, glass, zeolites, and the like. The carrier may include waste animal material, such as ground seashells or bones, diatoms, and the like.

In several embodiments, the particulate composition may include the core being present in an amount between about 75 wt % to about 99.5 wt % of the particulate composition. The core may be present in an amount in wt % with respect to the particulate composition of about one or more of: 50, 55, 60, 65, 70, 75, 80, 85, 90, 91, 92, 93, 94, 95, 96, 97, 98, 99, and 99.5. The core may be present in an amount in wt % with respect to the particulate composition between any of the preceding values, for example, between about 85 and about 90, and the like. For example, the core may be present in an amount with respect to the particulate composition of about 87 wt %.

In various embodiments, each core may include pores. The pores may be substantially void of one or more of the thermo-softening binder and the powder. For example, the thermo-softening binder may form a coating that spans or blocks the pores, but does not substantially enter the pores. The thermo-softening binder, by blocking the pores, may exclude the powder from the pores. The pores may be determined to be substantially void of the thermo-softening binder by comparing the pore volume percentage of the unoccupied core, the average density of the uncoated core, the average density of the thermo-softening binder and the powder, and the average density of the particles in the particulate composition, and determining, by difference, the fraction of pores occupied by the thermo-softening binder and the powder. As used herein, the term “substantially void” means the volume of the pores being occupied by the thermo-softening binder and the powder is less than about one or more of 20%, 15%, 10%, 5%, 4%, 3%, 2%, or 1%, or a range between any two of the preceding values, for example, between about 1% and about 5%.

In various embodiments, the core may include one or more of: a nutrient, a seed, an agricultural agent, and a carrier.

For example, the core may include the nutrient as one or more of a primary nutrient, a secondary nutrient, and a micronutrient. The nutrient included by the core may include one or more elements, e.g., one or more of: nitrogen, phosphorus, potassium, magnesium, sulfur, calcium, boron, copper, iron, manganese, molybdenum, nickel, and zinc, e.g., in the form of any compound described herein that includes such elements. The core may include, for example, one or more of: urea, ammonium sulfate, ammoniated phosphate, potassium sulfate, potash, granular sulfur, ignimbrite, copper sulfate, iron sulfate, manganese sulfate, nickel sulfate, zinc sulfate, calcium chloride, calcium carbonate, calcium silicate, calcium phosphate, calcium sulfate, and the like. In some embodiments, the core may include calcium sulfate or ammonium sulfate.

In some embodiments, the core may include a seed. The seed may include corn seed. The seed may include soybean seed. The seed may include grass seed. The seed may include the seed or spore of one of: corn, soybean, wheat, grass, hay, clover, cotton, sorghum, barley, canola, bean, sunflower, oat, pea, lentil, rye, rice, peanut, sugar beet, a vegetable, a microorganism, a fungus (e.g., mushroom) and the like. The seed may include any seed or spore characterized by a SGN of greater than about 80.

In various embodiments, the core may include one or more carriers. The carrier may include, for example, waste plant material, such as pollen grains, ground husks, shells, cores, skins, stalks, and the like. The carrier may include, for example, inert minerals, such as silica, clay, alumina, glass, zeolites, and the like. The carrier may include waste animal material, such as ground seashells or bones, diatoms, and the like.

In several embodiments, the particulate composition may include the powder being present in an amount in wt % with respect to the particulate composition of about one or more of: 1, 2, 3, 4, 5, 6, 7, 8, 9, 10, 11, 12, 13, 14, 15, 16, 17, 18, 19, and 20, or a range between any of the preceding values, for example, between about 2 and about 15, about 3 and about 7, about 8 and about 13, and the like. The powder may be present in about 11 wt % with respect to the particulate composition. The powder may be present in an amount greater than 1 wt % with respect to the particulate composition.

In many embodiments, the particulate composition may include the powder in a coating layer being present in an amount in wt % with respect to the plurality of cores of about one or more of: 0.02, 0.05, 0.1, 0.3, 0.5, 0.7, 0.9, 1.0, 1.1, 1.3, 1.5, 1.7, 1.9, 2.0, 2.2, 2.5, 2.7, and 3.0, or a range between any of the preceding values, for example, between about 1 and about 2.5, about 0.5 and about 1.5, and the like. The powder may be present in a coating layer in about 1.1 wt % with respect to the plurality of cores. The powder may be present in a coating layer in about 2.2 wt % with respect to the plurality of cores.

The powder may be characterized by SGN number. For example, the powder may be characterized by an SGN number of about, or less than about, one or more of 30, 27.5, 25, 22.5, 20, 17.5, 15, 12.5, 10, 9, 8, 7, 6, 5, 4, 3, 2, or 1, or a range between any two of the preceding SGN values. The powder may include particles characterized by an SGN of less than about 22.5, or less than about 20. The powder may include particles characterized by an SGN of less than about 15. The powder may include particles characterized by an SGN between about 9 and about 20, between about 5 and about 20, and the like.

In various embodiments, the powder may include any nutrient or agricultural agent described herein, for example, any primary nutrient, secondary nutrient, or micronutrient. For example, the micronutrient may include an agricultural micronutrient. The agricultural nutrient may provide nutrients to one or more of: corn, soybean, wheat, grass, hay, clover, cotton, sorghum, barley, canola, bean, sunflower, oat, pea, lentil, rye, rice, peanut, sugar beet, a vegetable, a microorganism, a fungus (e.g., mushroom) and the like. The micronutrient may include an animal micronutrient. The animal micronutrient may provide nutrients to a subject of one or more of: mammals, aquacultured organisms (fish, crustaceans, and the like), cattle, pigs, sheep, goats, horses, chickens, humans, insects, and the like.

In various embodiments, the powder may include one or more of any: agricultural nutrient, animal nutrient, and agricultural agent as described herein. For example, the powder may include one or more of: a primary nutrient, a secondary nutrient, and a micronutrient. The powder may include, for example, one or more compounds comprising one or more of: boron, chlorine, fluorine, iodine, copper, iron, manganese, molybdenum, nickel, zinc, cobalt, magnesium, chromium, calcium, sodium, sulfur, nitrogen, potassium, phosphorus, selenium, and silicon. The powder may include one or more of: sodium borate; boric acid; iron sulfate; iron oxide; manganese chloride; manganese sulfate; manganese oxide; zinc oxide; zinc sulfate; magnesium sulfate, magnesium carbonate; magnesium oxide; urea; and a methylene urea. The powder may include, for example, zinc sulfate and zinc oxide.

In several embodiments, the particulate composition may include the thermo-softening binder. The thermo-softening binder may be present in an amount in wt % with respect to the particulate composition of about one or more of: 0.1, 0.2, 0.3, 0.4, 0.5, 1.0, 1.5, 2.0, 2.5, 3.0, 3.5, 4.0, 4.5, 5, 6, 7, 8, 9, 10, 15, and 20. The thermo-softening binder may be present in an amount in wt % with respect to the particulate composition between any of the preceding values, for example, between about 0.5 and about 5, about 2 and about 4, between about 2.5 and about 3.5, and the like. In some embodiments, the thermo-softening binder may be present in an amount with respect to the particulate composition of greater than 5 wt %. In some embodiments, the thermo-softening binder may be present in an amount with respect to the particulate composition of about 2 wt %. Each particle in the particulate composition may include an outermost layer that includes the thermo-softening binder substantially absent the powder. For example, a final coating step in manufacturing the particulate composition may include application of a coating layer of the thermo-softening binder alone, without the powder.

In several embodiments, the thermo-softening binder may include one or more of: fatty acids, fatty acid esters, and rosin. In many embodiments, the thermo-softening binder may include fatty acids, fatty acid esters, and rosin. For example, the thermo-softening binder may include HD-40 (Dustech, LLC, Tampa, Fla.). For example, the thermo-softening binder may include HD-60 (Dustech, LLC, Tampa, Fla.). In many embodiments, the thermo-softening binder may include one or more of: fatty acids, fatty acid esters, rosin, hydrocarbons, petroleum products, asphalt, vegetable oils, vegetable shortening, lard, molasses, animal fat, tallow oil, and wax. In some embodiments, the thermo-softening binder may include petroleum products, vegetable oils, and asphalt.

In several embodiments, the thermo-softening binder may be characterized by a liquefaction temperature of greater than about 30° C. The thermo-softening binder may be characterized by a liquefaction temperature of greater than about 45° C. The thermo-softening binder may be characterized by a liquefaction temperature in ° C. of greater than one or more of about 25, 30, 35, 40, 45, 50, 55, 60, 65, 70, 75, 80, 85, 90, 95, and 100. The thermo-softening binder may be characterized by a liquefaction temperature in ° C. between any of the preceding values, for example, between about 30 and about 50, between about 40 and about 65, and the like. In some embodiments, the thermo-softening binder may be characterized by a liquefaction temperature of about 46-50° C. In other embodiments, the thermo-softening binder may be characterized by a liquefaction temperature of about 64-66° C. As used herein, a “liquefaction temperature” may refer to a temperature at atmospheric pressure in which a substance, such as a thermo-softening binder, transitions from a non-liquid state to a liquid state.

In several embodiments, the thermo-softening binder may be characterized as a gel or a semi-solid at temperature of less than about 60° C. In several embodiments, the thermo-softening binder may be characterized as a gel or a semi-solid at temperature of less than about 45° C. The thermo-softening binder being characterized as a gel or semi-solid at a temperature in ° C. of less than about one or more of: 65, 60, 55, 50, 45, 40, 35, 30, and 25. The thermo-softening binder being characterized as a gel or semi-solid and solidifying at a temperature in ° C. between any of the preceding values, for example, between about 40 and about 55, between about 45 and about 30, and the like.

In various embodiments, the thermo-softening binder may be characterized by a tack value in milliNewtons (mN) of at least about one or more of about: 0.1, 0.5, 1, 2, 3, 4, 5, 6, 7, 8, 9, 10, 15, 20, 25, 30, 35, 40, 45, 50, or a range between any two of the preceding values, for example, between about 1 and about 50. The tack value may be determined according to ASTM D2979-01, “Standard Test Method for Pressure-Sensitive Tack of Adhesives Using an Inverted Probe Machine,” Reapproved 2009, American Society for Testing Materials, West Conshohocken, Pa. Suitable testing machines may include, for example, a PT-1000 POLYKEN™ Probe Tack (ChemInstruments, Fairfield, Ohio). Briefly, a sample of the thermo-softening binder is liquefied and allowed to form a uniform 0.2 mm layer on a stainless steel substrate, which is affixed in the test apparatus. The temperature of the sample is equilibrated at 25° C. The test probe is brought into contact with the layer of the binder at a speed of 10±0.1 mm per second, held on the binder for a dwell time of 1±0.01 seconds at pressure of 9.79±kPa, and withdrawn at a speed of 10±0.1 mm per second. The force required to withdraw the probe from the binder may be recorded as a tack value in mN.

In many embodiments, the thermo-softening binder may be characterized by a viscosity at a temperature of 100° C. at atmospheric pressure in centiPoise of less than one or more of about 10, 20, 30, 40, 50, 60, 70, 80, 90, 100, 125, 150, 175, 200, 225, 250, 300, 400, 450, 500, 600, 700, 800, 900, 1000, 2500, 5000, 7500, 10000, 15000, 20000, 30000, 40000, 50000, e.g., less than about 400, or a range between any two of the preceding values, for example, between about 15 and about 50000.

In various embodiments, the thermo-softening binder may be characterized by a penetration value. The thermo-softening binder may be characterized by a penetration value in mm of about one or more of: 5, 10, 15, 20, 25, 30, 35, 40, 45, 50, 55, 60, and 65. The thermo-softening binder may be characterized by a penetration values in mm in a range between any of the preceding values, for example, between about 20 and about 30, between about 45 and about 50, and the like. The thermo-softening binder may be characterized by a penetration value of 0.1 mm interval at or between any of the preceding values, for example, the thermo-softening binder may be characterized by a penetration value of about 23.4, 31.2, 44.9, and the like. Suitable testing machines may include, for example, a K19500 Penetrometer with K20800 Penetration Cone (Koehler Instrument Co., Bohemia, N.Y.).

In many embodiments, the penetration value may be determined according to one or more of: ASTM D5-06, ASTM D217-02, ASTM D937-97, ASTM D1403-02, ASTM D4950-01, ASTM D5329-96, ASTM D1321, and ASTM D2884. For example, the penetration value may be determined according to ASTM D5-06, “Standard Test Method for Method for Penetration of Bituminous Materials,” Approved June 2006, American Society for Testing Materials, West Conshohocken, Pa. Briefly, a sample of the thermo-softening binder is liquefied and cooled under controlled conditions in a cylindrical, flat-bottom container. The penetration is measured with a penetrometer by applying a standard needle to the sample under specified conditions. For example, the penetration value may be determined according to ASTM D217-02, “Standard Test Methods for Cone Penetration of Lubricating Grease.” Approved December 2002, American Society for Testing Materials, West Conshohocken, Pa. For example, the penetration value may be determined according to ASTM D937-97, “Standard Test Method for Cone Penetration of Petrolatum.” Approved November 1997, American Society for Testing Materials, West Conshohocken, Pa. For example, the penetration value may be determined according to ASTM D1403-02, “Standard Test Methods for Cone Penetration of Lubricating Grease Using One-Quarter and One-Half Scale Cone Equipment.” Approved December 2002, American Society for Testing Materials, West Conshohocken, Pa. For example, the penetration value may be determined according to ASTM D4950-01, “Standard Classification and Specification for Automotive Service Greases.” Approved May 2004, American Society for Testing Materials, West Conshohocken, Pa. For example, the penetration value may be determined according to ASTM D5329-96, “Standard Test Methods for Sealants and Fillers, Hot-Applied, For Joints and Cracks in Asphaltic and Portland Cement Concrete Pavements.” Approved January 1996, American Society for Testing Materials, West Conshohocken, Pa.

In some embodiments, the core may include ammonium sulfate or calcium sulfate, and the powder may include any of the powders recited herein. For example, the core may include ammonium sulfate, and the powder may include one of: sodium borate; boric acid; sodium borate and boric acid; iron sulfate; iron oxide; manganese chloride and manganese sulfate; manganese sulfate; manganese oxide; zinc sulfate and zinc oxide; zinc sulfate; zinc oxide; magnesium sulfate, magnesium carbonate, and magnesium oxide; magnesium oxide; urea; and methylene urea.

In some embodiments, the core may include ammonium sulfate, and thermo-softening binder may include fatty acids and fatty esters; and the powder may include any of the powders recited herein. For example, the core may include ammonium sulfate, the thermo-softening binder may include fatty acids and fatty esters; and the powder may include one of: sodium borate; boric acid; sodium borate and boric acid; iron sulfate; iron oxide; manganese chloride and manganese sulfate; manganese sulfate; manganese oxide; zinc sulfate and zinc oxide; zinc sulfate; zinc oxide; magnesium sulfate, magnesium carbonate, and magnesium oxide; magnesium oxide; urea; and methylene urea. In other embodiments, the core may include ammonium sulfate; the thermo-softening binder may include fatty acids, fatty esters, and rosin; and the powder may include any of the powders recited herein. For example, the core may include ammonium sulfate; the thermo-softening binder may include fatty acids, fatty esters, and rosin; and the powder may include one of: sodium borate; boric acid; sodium borate and boric acid; iron sulfate; iron oxide; manganese chloride and manganese sulfate; manganese sulfate; manganese oxide; zinc sulfate and zinc oxide; zinc sulfate; zinc oxide; magnesium sulfate, magnesium carbonate, and magnesium oxide; magnesium oxide; urea; and methylene urea. In some embodiments, the core may include ammonium sulfate; the thermo-softening binder may include fatty acids, fatty esters, and rosin; and the powder may include zinc sulfate and zinc oxide.

In several embodiments, the particulate composition may include about 15-25 wt % nitrogen; about 15-24 wt % sulfur; and about 0.2-8 wt % zinc. For example, the particulate composition may include about 19 wt % nitrogen, 22 wt % sulfur, and about 2 wt % zinc. In other embodiments, the particulate composition may include: 40-42 wt % nitrogen and about 0.4-1.7 wt % zinc; 18-20 wt % nitrogen, 20-23 wt % sulfur, and about 1.5-2.0 wt % zinc; 8-10 wt % nitrogen, 42-48 wt % phosphorus (P2O5), and about 0.2-2.5 wt % boron; 44-48 wt % potassium (K2O), 14-16 wt % sulfur, and about 0.2-2.0 wt % boron; 28-30 wt % calcium, 3-4 wt % magnesium, and about 0.05-0.25 wt % bifenthrin (an insecticide); 80-95 wt % wheat seed and about 1.5-6.5 wt % copper; 85-95 wt % corn seed, and about 0.9-3.5 wt % zinc.

In many embodiments, the particulate composition may include a core:powder ratio of about 85:15 to about 99:1 by weight. The particulate composition may include a core:powder ratio by weight of about: 70:30, 75:25, 80:20; 82:18, 85:15, 88:12, 89:11, 90:10, 91:9, 92:8, 93:7, 94:6, 95:5, 96:4, 97:3, 98:2, and 99:1. The particulate composition may include a core:powder ratio by weight between any of the preceding values, for example, between about 90:10 and about 93:7, between about 75:25 and 95:5, and the like.

In many embodiments, the particulate composition may include a thermo-softening binder:powder ratio of about 1:1 to about 1:5 by weight. The particulate composition may include a thermo-softening binder:powder ratio by weight of about: 3:1, 2:1, 1:1, 1:2, 1:3, 1:4, 1:5, 1:6, 1:7, 1:8, 1:9, and 1:10. The particulate composition may include a thermo-softening binder:powder ratio by weight between any of the preceding values, for example, between about 1:1 and about 1:3, between about 2:1 and about 1:5, and the like. The particulate composition may include a thermo-softening binder:powder ratio by weight of about 2.8:3.8 to about 1:3.8.

In several embodiments, the particulate composition may include at least part of the thermo-softening binder and powder in the form of a matrix. In other words, the powder may be at least partly entrapped within the gelatinous or semi-solid thermo-softening binder. In other embodiments, the particulate composition may include at least part of the powder in the form of an adhered dust. In other words, the powder may be at least partly adhered or coated to the thermo-softening binder. In some embodiments, the powder is partly entrapped within and partly adhered to the thermo-softening binder.

In various embodiments, the particulate composition may include a parting agent. The parting agent may include one or more of: talc, diatomaceous earth, parting clay, powdered limestone/gypsum (mined or synthetic), starch, and the like.

In many embodiments, the particulate composition may include the particulate composition prepared by any of the methods described herein.

In various embodiments, a method for producing a flowable, dust-mitigated particulate composition is provided. The method may include providing a plurality of cores. The method may include heating a thermo-softening binder to a temperature effective to liquefy the thermo-softening binder to provide a liquefied thermo-softening binder. The method may include forming one or more coating layers disposed concentrically about each core. Forming each coating layer may include contacting each core with the liquefied thermo-softening binder to dispose a binder layer concentrically about each core. Forming each coating layer may include contacting each binder layer with a powder to provide a powder-binder-layer disposed concentrically about each core. Forming each coating layer may include cooling the powder-binder-layer to solidify the liquefied thermo-softening binder effective to bind the powder to the binder layer to form each coating layer. The method may thereby form the flowable, dust-mitigated particulate composition as a plurality of the cores comprising the one or more coating layers disposed concentrically about each core.

As used herein, the term “about the core” is intended to include each coating layer about the core as a subsequent coating layer is applied, such that the coating layers form concentric layers about the core. For example, the powder-binder-core, a powder-binder-powder-binder-core, a powder-binder-powder-binder-powder-binder-core and the like, are each intended to be included within the term “core” upon application of a subsequent coating layer.

In many embodiments, the powder-binder-core may be the flowable, dust-mitigated particulate composition. The powder-binder-core including subsequent coating layers may be the flowable, dust-mitigated particulate composition.

In several embodiments, the particulate composition is substantially dust-free, e.g., as described herein.

In some embodiments, the method may include heating the thermo-softening binder to a temperature in ° C. of about, or at least about one or more of: 35, 40, 45, 50, 55, 60, 65, 70, 75, 80, and 90, e.g., greater than about 90, or a range between any two of the preceding values, for example, between about 55 and about 65, about 45 and about 55, and the like. The method may include heating the thermo-softening binder to a temperature at above one or more of a softening point and a melting or liquefaction point of the thermo-softening binder. The method may include heating the thermo-softening binder to a temperature effective to cause a change in viscosity of the thermo-softening binder. For example, the heating may be effective to cause the thermo-softening binder to reach a viscosity in cP of less than about one or more of 10, 20, 30, 40, 50, 60, 70, 80, 90, 100, 125, 150, 175, 200, 225, 250, 300, 400, or 450, 500, e.g., less than about 400, or to a range between any two of the preceding values, for example, between about 5 and about 250, and the like. The method may include heating the thermo-softening binder at a pressure of about 1 atmosphere. The method may include heating the thermo-softening binder at a pressure in atmospheres of less than about one or more of 1, 0.9, 0.8, 0.7, 0.6, 0.5, 0.4, 0.3, 0.2, or 0.1.

In several embodiments, the contacting each core with the liquefied thermo-softening binder may include spraying the liquefied thermo-softening binder to contact each core with the liquefied thermo-softening binder. The method may include spraying the liquefied thermo-softening binder to contact each core with the liquefied thermo-softening binder at a spray pressure in psig of about one or more of: 0.5, 5, 10, 25, 50, 75, 100, 150 and 200. The method may include spraying the liquefied thermo-softening binder to contact each core with the liquefied thermo-softening binder at a spray pressure of up to about 200 psig. The method may include spraying the liquefied thermo-softening binder at a spray pressure in psig between any of the preceding values, for example, between about 5 and about 10, between about 50 and about 75, and the like. The method may include spraying the liquefied thermo-softening binder at a spray pressure of about 5 psig.

In many embodiments, the contacting each core with the liquefied thermo-softening binder may include spraying the liquefied thermo-softening binder at a rate in grams of binder per second in view of an amount of core material. For example, the contacting each core with the liquefied thermo-softening binder may include spraying the liquefied thermo-softening binder at a rate, in grams of binder per second with respect to about 45 kg core material, of about one or more of: 5, 10, 15, 20, 25, 30, 35, 40, 45, 50, 55, and 60. The contacting each core with the liquefied thermo-softening binder may include spraying the liquefied thermo-softening binder at a rate in g/s between any of the preceding values, for example, between about 20 and about 40, between about 15 and about 55, and the like. The contacting each core with the liquefied thermo-softening binder may include spraying the liquefied thermo-softening binder at a rate of greater than 60 g/s. The contacting each core with the liquefied thermo-softening binder may include spraying the liquefied thermo-softening binder at a rate of about 35 g/s.

For example, the contacting each core with the liquefied thermo-softening binder may include spraying the liquefied thermo-softening binder at a rate, in grams of binder per second with respect to about 2,720 kg core material, of about one or more of: 100, 110, 120, 130, 140, 150, 160, 170, 180, 190, 200, 210, 220, 230, 240, 250, 260, 270, 280, 290, and 300. The contacting each core with the liquefied thermo-softening binder may include spraying the liquefied thermo-softening binder at a rate in g/s between any of the preceding values, for example, between about 150 and about 250, between about 180 and about 280, and the like. The contacting each core with the liquefied thermo-softening binder may include spraying the liquefied thermo-softening binder at a rate of about 190 g/s.

In many embodiments, the method may allow for a particulate composition that is substantially free of one or more of agglomerated cores and agglomerated powder. As used herein, the term “substantially free” may refer to less than about 5-10 wt % of the particulate composition. As used herein, the term “agglomerated” may refer to adhering via binder. For example agglomerate cores may include cores that are adhered together via binder. For example, agglomerated powder may include powder that is adhered or mudded together via binder.

In several embodiments, the method may include agitating the thermo-softening binder and the cores at a rate effective to evenly distribute the thermo-softening binder among the cores. The method may include agitating the thermo-softening binder and the cores at a rate effective to mitigate agglomeration of the cores by the binder. The method may include agitating the thermo-softening binder, the cores, and the powder effective to mitigate agglomeration of the cores and/or the powder by the binder. The agitating may include one or more of: mixing, tumbling, sonicating, stirring, shaking, vibrating, and the like. In some embodiments, the addition of the powder may be effective to mitigate agglomeration of the cores by the binder. In some embodiments, addition of a parting agent may be effective to mitigate agglomeration of the cores by the binder. For example, the parting agent may be added subsequent to the formation of a final coating layer, such that the parting agent may adhere to any remaining portion of exposed binder on the final coating layer. The parting agent may include, for example, talc, diatomaceous earth, parting clay, starch, and powdered limestone/gypsum.

In some embodiments, the method may include allowing the thermo-softening binder and the plurality of cores to agitate for a period of time prior to contacting the binder-layer with the powder.

In various embodiments, the method may include allowing the thermo-softening binder and the plurality of cores to agitate for a period of time in seconds per kilogram of thermo-softening binder of about one or more of: 5, 10, 20, 30, 40, 50, 60, 70, 80, 90, and 100. The method may further include allowing the thermo-softening binder and the plurality of cores to agitate for a period of time in seconds per kilogram of thermo-softening binder between any of the preceding values, for example, between about 5 and about 10, and the like.

In some embodiments, the method may include allowing the binder-core and powder to agitate for a period of time prior to cooling the powder-binder core. The method may include allowing the binder-core and powder to agitate for a period of time in seconds per kilogram of thermo-softening binder of about one or more of: 5, 10, 20, 30, 40, 50, 60, 70, 80, 90, and 100. The method may include allowing the binder-core and powder to agitate for a period of time in seconds per kilogram of thermo-softening binder between any of the preceding values, for example, between about 5 and about 10, and the like. In some embodiments, the method may include allowing the binder-core and powder to agitate for a period of time greater than 100 s/kg. In other embodiments, the method may include allowing the binder-core and powder to agitate for a period of time greater than about 10,000 s/kg. In some embodiments, the method may include allowing the binder-core and powder to agitate for a period of time less than about 2 s/kg.

In some embodiments, the contacting each core with the liquefied thermo-softening binder further comprising heating the cores to a temperature in ° C. of greater than about one or more of: 90, 85, 80, 75, 70, 65, 60, 55, 50, 45, 40, 35, 30, and 25. The method may further include heating the cores and/or the binder-cores to a temperature greater than a gelatinous or solidifying temperature of the thermo-softening binder. For example, the cores and/or the binder-cores may be heated to a temperature in ° C. of greater than about one or more of: 90, 85, 80, 75, 70, 65, 60, 55, 50, 45, 40, 35, 30, and 25.

In several embodiments, the forming the one or more coating layers may include contacting an amount of the liquefied thermo-softening binder in weight % with respect to an amount of the plurality of cores of one or more of about: 0.02, 0.05, 0.1, 0.3, 0.5, 0.7, 0.9, 1.0, 1.1, 1.3, 1.5, 1.7, 1.9, 2.0, 2.2, 2.4, 2.6, 2.8, and 3.0. For example, the thermo-softening binder may be applied in an amount of about 1.5 wt % with respect to an amount of the plurality of cores. The thermo-softening binder may be applied in an amount of about 0.5 wt % with respect to an amount of the plurality of cores. In many embodiments, thermo-softening binder layers may be applied in an amount greater than, less than, or equal to previous or subsequent thermo-softening binder layers. For example, the thermo-softening binder of one or more coating layers may be applied in an amount as a percentage with respect to the first thermo-softening layer of about one or more of: 5, 10, 15, 20, 25, 30, 35, 50, 45, and 50. Also, for example, a first thermo-softening binder layer may be present in an amount with respect to an amount of the plurality of cores of about 1.1 wt %, and the following thermo-softening binder layer may be applied in an amount with respect to the plurality of cores of about 0.2 wt %, and the like.

In several embodiments, the method may include applying more than one coating layer. For example, the method may include contacting each core with a first amount of the thermo-softening binder to form a first binder layer in contact with each core. The method may include contacting each core with subsequent amounts of the thermo-softening binder to form subsequent binder layers concentrically about preceding binder layers, e.g., the first binder layer. One or more of the subsequent amounts of the thermo-softening binder may be a percentage of the first amount of the thermo-softening binder of about one or more of: 5, 10, 15, 20, 25, 30, 35, 40, 45, and 50.

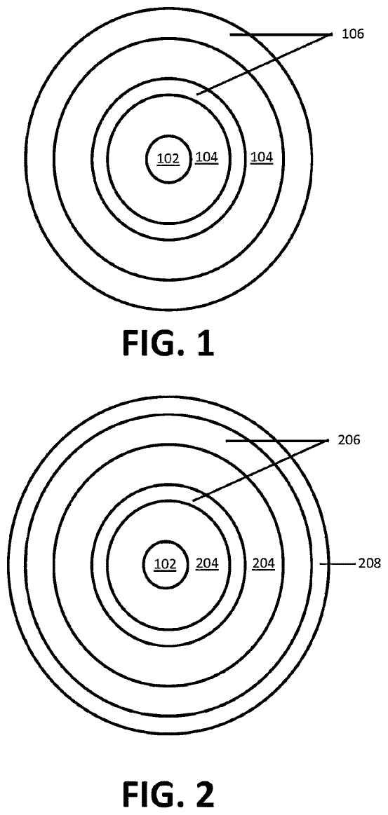

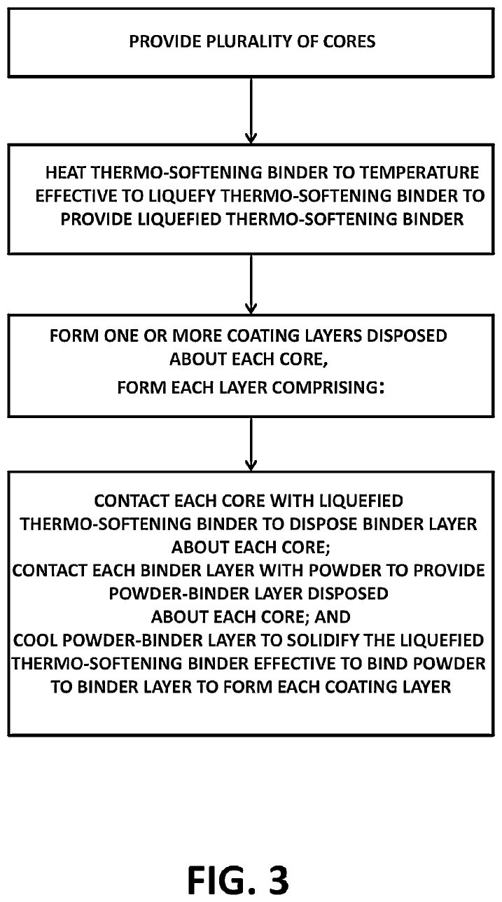

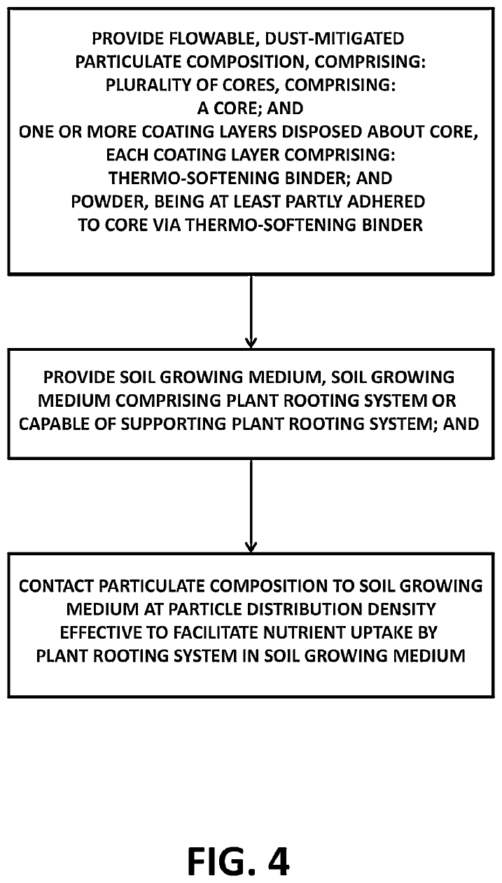

The method may include forming each coating layer including contacting each core with the liquefied thermo-softening binder to provide the binder layer and contacting each binder layer with the powder to provide each binder-powder layer. The method may include contacting each binder-powder layer with the liquefied thermo-softening binder to provide a binder_{(N)}-[powder-binder]_{(M)}-core. N may be 0 or 1. M may be an integer from 1 to 10. For example, FIG. 1 illustrates a binder_{(N)}-[powder-binder]_{(M)}-core, where N is 0 and M is 2. A core 102 may be coated with a binder-layer 104. Binder-layer 104 may be coated with a powder-layer 106. Powder-layer 106 may include any parting agent described herein. Binder-layer 104 and powder-layer 106 may form one coating layer, e.g., a powder-binder layer. For example, FIG. 2 illustrates a binder_{(N)}-[powder-binder]_{(M)}-core, where N is 1 and M is 2. A core 202 may be coated with a binder-layer 204. Binder-layer 204 may be coated with a powder-layer 206. Binder-layer 204 and powder-layer 206 may form one coating layer, e.g., a powder-binder layer. An outermost binder-layer 208 may be disposed absent a subsequent powder-layer.

In various embodiments, the method may be operated as a batch process. In some embodiments, the method may be operated as a continuous process.

In several embodiments, the method may produce the flowable, dust mitigated particulate composition according to any aspect of the flowable, dust mitigated particulate composition as described herein, for example, aspects of the nutrients, the core, the thermo-softening binder, the powder, and the like.

In various embodiments, a method for nutrient uptake by a plant rooting system is provided. The method may include providing a flowable, dust-mitigated particulate composition. The particulate composition may include a plurality of particles. Each particle may include a core and one or more coating layers disposed about the core. Each of the one or more coating layers may include a thermo-softening binder and a powder. The powder may be at least partly adhered to the core via the thermo-softening binder. The method may include providing a soil growing medium. The soil growing medium may include the plant rooting system. The soil growing medium may be capable of sustaining the plant rooting system. The method may include contacting the particulate composition to the soil growing medium at a particle distribution density effective to facilitate nutrient uptake by the plant rooting system in the soil growing medium.

As used herein, the “particle distribution density” refers to the numbers of particles of the particulate composition per square foot when the particulate composition is contacted to the soil growing medium at a designated rate in lbs/acre. The particle distribution density is in reference to the particulate composition as a whole. A particle distribution density may be calculated as follows: (#lbs/acre)*(acre/43,560 sqft)*(453.59 g/lb)*(particle/#g)=particles per square ft.

Accordingly, in several embodiments, the particle distribution density may be greater than about 10 at a rate in lbs/acre of about one or more of: 0.04, 0.1, 0.2, 0.5, 1, 2, 3, 5, 10, 14, 15, 18, 20, 25, 30, 35, 40, 45, 50, 55, 60, 65, 70, 75, 80, 85, 90, 95, 100, 110, 120, 130, 140, 150, 160, 165, 170, 175, 180 190, 200, 220, 240, 260, 280, 300, 400, 500, 600, and 700, or a rate between any of the preceding values. In many embodiments, the particle distribution density may be greater than about one or more of: 3, 4, 5, 7, 9, 10, 12, 14, 16, 18, 20, 23, 25, 27, 30, 35, 40, 45, 50, 100 and 150 at a rate in lbs/acre of any of the rates described herein. For example, the particle distribution density may be greater than 20. The particle distribution density may be between any of the preceding values, for example, between about 7 and about 12, between about 16 and about 25, and the like.

In one embodiment, an example corn/zinc sulfate particulate composition may include about 92.5% corn and about 1.8% zinc. The particulate composition may be characterized by an SGN of about 520-830. The corn/zinc particulate composition may be characterized by a particle distribution density of about 13.1 at a rate of about 27 lb/acre to provide about 30,000 seeds/acre and about 0.5 lb/acre zinc.

In another embodiment, an example calcium carbonate/bifenthrin insecticide particulate composition may include about 28.9% calcium, about 3.9% magnesium, and about 0.1% bifenthrin insecticide on a carrier characterized by an SGN of 265. The insecticide particulate composition may be characterized by a particle distribution density of about 21.9 at a rate of about 45.1 lb/acre to provide about 13.1 lb/acre calcium, 1.7 lb/acre magnesium, and about 0.1 lb/acre bifenthrin.

In one embodiment, an example calcium/zinc particulate composition may include about 18.7% calcium, about 15.2% sulfur, and about 3% zinc. The particulate composition may be characterized by an SGN of about 265. The calcium/zinc particulate composition may be characterized by a particle distribution density of about 31.9 at a rate of about 65.9 lb/acre to provide about 12.4 lb/acre calcium, about 10 lb/acre sulfur, and about 2 lb/acre zinc.

In one embodiment, an example calcium/boron particulate composition may include about 18.9% calcium, about 15.3% sulfur, and about 1.5% boron. The particulate composition may be characterized by an SGN of about 265. The calcium/zinc particulate composition may be characterized by a particle distribution density of about 31.6 at a rate of about 65.3 lb/acre to provide about 12.4 lb/acre calcium, about 10 lb/acre sulfur, and about 1 lb/acre boron.

In one embodiment, an example potassium sulfate/sodium borate particulate composition may include about 48.2% potassium, about 16.4% sulfur, and about 0.2% boron. The particulate composition may be characterized by an SGN of about 306. The potash sulfate particulate composition may be characterized by a particulate distribution density of about 129 at a rate of about 415 lb/acre to provide about 200 lb/acre potassium, about 68 lb/acre sulfur, and about 1 lb/acre boron.

In one embodiment, an example MAP (mono-ammonium phosphate)/leonardite particulate composition may include about 8.7% nitrogen, about 43.5% phosphorus, and about 10.9% humic. The particulate composition may be characterized by an SGN of about 295. The MAP particulate composition may be characterized by a particulate distribution density of about 284 at a rate of about 460 lb/acre to provide about 40 lb/acre nitrogen, about 200 lb/acre phosphorus, and about 50 lb/acre humic.

In one embodiment, an example MAP (mono-ammonium phosphate)/sodium borate particulate composition may include about 9.6% nitrogen, about 48% phosphorus, and about 0.3% boron. The particulate composition may be characterized by an SGN of about 295. The MAP particulate composition may be characterized by a particulate distribution density of about 193 at a rate of about 312 lb/acre to provide about 30 lb/acre nitrogen, about 150 lb/acre phosphorus, and about 1 lb/acre boron.

In another embodiment, an example ammonium sulfate/zinc sulfate particulate composition may include about 19.6% nitrogen, about 23.2% sulfur, and about 1.6% zinc. The particulate composition may be characterized by an SGN of about 200-280, e.g., 235. The particulate composition may be characterized by a particulate distribution density of about 98 at a rate of about 128 lb/acre to provide about 25 lb/acre nitrogen, about 29.6 lb/acre sulfur, and about 2 lb/acre zinc.

In another embodiments, an example urea/zinc sulfate/leonardite particulate composition my include about 40.1% nitrogen, about 0.4% zinc, and about 9.6% humic. The particulate composition may be characterized by an SGN of about 260. The urea particulate composition may be characterized by a particulate distribution density of about 115 at a rate of about 125 lb/acre to provide about 50 lb/acre nitrogen, about 2.3 lb/acre sulfur, about 0.5 lb/acre zinc, and about 12 lb/acre humic.

In another embodiment, an example urea/zinc sulfate particulate composition may include about 42.7% nitrogen and about 1.7% zinc. The particulate composition may be characterized by an SGN of about 260. The urea particulate composition may be characterized by a particulate distribution density of about 108 at a rate of about 117 lb/acre to provide about 50 lb/acre nitrogen, about 1 lb/acre sulfur, and about 2 lb/acre zinc.

In various embodiments, the particulate composition may be characterized by a particulate distribution density at a rate effective to provide one or more elements at a rate described in the table below. For example, the particulate composition may be characterized by a particulate distribution density at a rate effective to provide 40-220 lb/acre nitrogen, and the like.

| Nutrient | | Rate (lbs/acre) |
|---|---|---|
| Nitrogen | N | 40-220 |
| Phosphorus | P | 25-165 |
| Potassium | K | 45-300 |
| Silica | Si | 15-700 |
| Calcium | Ca | 14-175 |
| Magnesium | Mg | 15-60 |
| Sulfur | S | 18-55 |
| Boron | B | 0.5-2 |
| Cobalt | Co | 0.04-0.13 |
| Chloride | Cl | 20 |
| Copper | Cu | 3-10 |
| Iron | Fe | 1-5 |
| Manganese | Mn | 1-20 |
| Molybdenum | Mo | 0.2-1 |
| Zinc | Zn | 1-10 |

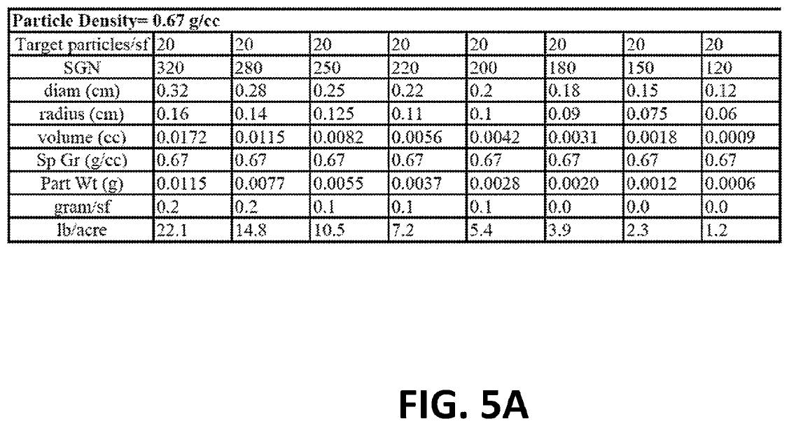

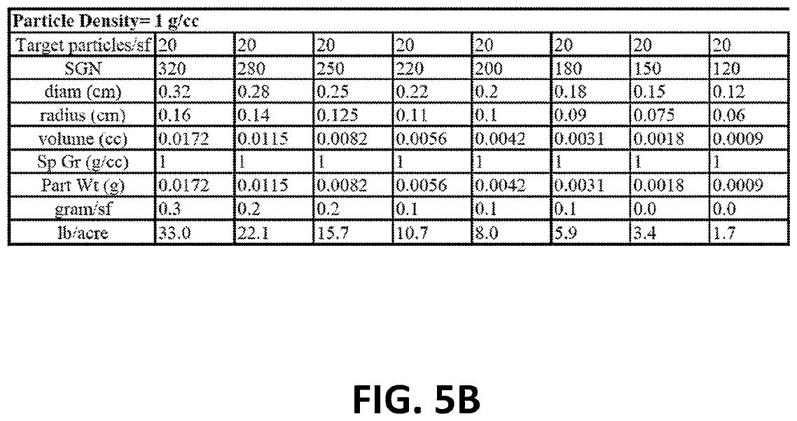

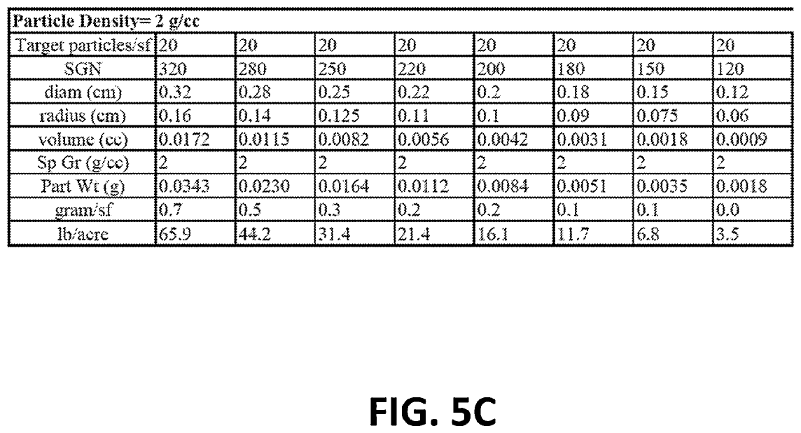

The nutrient uptake may be uniform at a particle distribution density of greater than about 10 at any of the rates in lb/acre described herein. In some embodiments, the nutrient uptake may be uniform at a particle distribution density of about 20 at any of the rate distributions described herein. The tables in FIG. 5A-C provide example calculations illustrating rates to achieve a particle distribution density of about 20 at various SGN values at particle densities of 0.67 g/mL, 1.0 g/mL, and 2.0 g/mL. The calculations are based on the assumption that all particles within the composition are about same particle size.

For example, a particulate composition may be characterized by a density of about 0.67 g/mL. See FIG. 5A. The particulate composition may be characterized by an SGN of about 200. At a density of about 0.67 g/mL and an SGN of about 200, the particulate composition may be characterized by a particle distribution density of 20 at a rate of about 5.4.

For example, a particulate composition may be characterized by a density of about 1.0 g/mL. See FIG. 5B. The particulate composition may be characterized by an SGN of about 200. At a density of about 1.0 g/mL and an SGN of about 200, the particulate composition may be characterized by a particle distribution density of 20 at a rate of about 8.0.

For example, a particulate composition may be characterized by a density of about 2 g/mL. See FIG. 5C. The particulate composition may be characterized by an SGN of about 200. At a density of about 02.0 g/mL and an SGN of about 200, the particulate composition may be characterized by a particle distribution density of 20 at a rate of about 16.1.

In some embodiments, the nutrient uptake may be uniform at a particle distribution density of between about 10-15 lb/acre at an SGN of less than about 250.

As used herein, the term “uniform” may refer to the ability of each plant rooting system within each acre to access the nutrients in quantities effective for growth and sustained health.

In several embodiments, the contacting the particulate composition to the soil growing medium may include spreading the particulate composition on a soil surface. The contacting the particulate composition to the soil growing medium may include spreading the particulate composition on a soil surface and further incorporating the particulate composition into the soil. The particulate composition may be incorporated into the soil with any conventional soil handling implement, such as a plough, a rototiller, a disc harrow, and the like.

In some embodiments, the contacting the particulate composition to the soil growing medium may include spreading the particulate composition on a soil surface along a plough furrow with a planter. In some embodiments, the contacting the particulate composition to the soil growing medium may include spreading the particulate composition on a soil surface along a plough furrow with a planter and incorporating the particulate composition into the soil with the planter.

In several embodiments, the contacting the particulate composition to the soil growing medium may include spreading the particulate composition on a soil surface and incorporating the particulate composition into the soil by applying water.

In some embodiments, the contacting the particulate composition to the soil growing medium may include banding the particulate composition within the soil.

In several embodiments, the method may utilize the flowable, dust mitigated particulate composition according to any aspect of the flowable, dust mitigated particulate composition as described herein, for example, aspects of the nutrients, the core, the thermo-softening binder, the powder, and the like.

### EXAMPLES

### Example 1: Urea/Magnesium Particulate Composition with HD-40 Binder

Granular urea core material (2 kg) (Koch Nitrogen Co., Enid, Okla.) was added to a trapezoidal mixing drum having a base measurement of about 23 cm, a mouth measurement of about 29 cm, and a height measurement of about 23 cm. The drum was set at a shaft angle of about 40 degrees relative to the direction perpendicular to the force of gravity and rotated at a rate of about 45 RPM. The core materials were heated with a Wagner Model HT 1000 heat gun to about 56° C. HD-40 (204.82 g) binder was heated 119° C. on a Faberware Solid Double Burner Model HP 202-D11 hot plate, and added to a Husky Siphon Feed Detail Spray Gun Model-H4910DSG. The binder was sprayed onto the rotating bed of urea until the core materials appeared wet and marginally free-flowing. WOLF TRAX Mg DDP (30% magnesium powder) (40 g) was added to the wet core material in 20 g increments until the mixture appeared flowable and dusty. The blend was mixed for 20 seconds and then further sprayed with second charge of HD-40 for 20 seconds. A second charge of powder (40 g) was then applied. The process was repeated according to the table below until a total of five layers of binder-powder were added. A total of 68.27 g of HD-40, and a total of 200 g of powder were applied.

| Core Description | Urea |
|---|---|
| Core Supplier | Koch Nitrogen |
| Core Weight (grams) | 2000 |
| Core Temperature (F.) | 133 |
| Binder Description | HD-40 |
| Binder Supplier | Dustech LLC |
| Binder Weight (grams) | 68.27 |
| Binder Temperature (F.) | 246 |
| Powder Description | Wolftrax 30% Magnesium |
| Powder Source | Compass Minerals |
| Powder Weight (grams) | 200 |
| Powder Temperature (F.) | 72 |
| Addition Sequence: | grams/sec |
| Binder | 8.9/20 |
| Powder | 40/40 |
| Mix | 20 |
| Binder | 8.9/20 |
| Powder | 40/49 |
| Mix | 89 |
| Binder | 6.2/14 |
| Powder | 40/53 |
| Mix | 144 |
| Binder | 4.9/11 |
| Powder | 40/60 |
| Mix | 0 |
| Binder | 39.3/88 |
| Powder | 40/60 |
| Mix | 25 |

### Example 2: CaSO₄/Zn Particulate Composition with HD-40 Binder

A High Intensity Mixer (HIM) by A. J. Sackett & Sons Company was charged with 45 kg of granulated calcium sulfate (Charah, Inc., Louisville, Ky.). The calcium sulfate was maintained at a temperature of 6° C. HD-40 (Dustech, LLC, Tampa, Fla.), a thermo-softening proprietary blend of fatty acids, fatty acid esters, and rosin, was heated to about 89° C. to provide a thin, flowable liquid. The liquefied thermo-softening binder (525 g) was sprayed onto the surface of the core material using a Spray Systems 9508 nozzle at a spray pressure of 5 psig for 15 s (35 g/s rate). The calcium sulfate and the liquefied HD-40 were allowed to mix for 6 s before 500 g WOLF TRAX 62% Zn DDP (Compass Minerals, Overland Park, Kans.) a powdered zinc sulfate and zinc oxide blend, was added over a period of 6 s to the mixer. The resulting mixture was allowed to mix for an additional 33 s to evenly distribute the powder. No visible dust was observed. No dust-binder or core-binder agglomeration was observed. A second charge of liquefied HD-40 (175 g) was sprayed onto the powder-binder-core for a period of 5 s, and the resulting mixture was allowed to mix for 12 s. A second charge of Zn powder was added to the binder-powder-binder-core over a period of 5 s, and the blend was allowed to mix for 27 s. No visible dust was observed. No agglomeration was observed. A third charge of HD-40 (175 g) was added to the HIM over a period of 5 s, and the mixture was allowed to blend for 15 s. A third charge of Zn powder (500 g) was added over a period of 3 s to provide a mixture that appeared to remain tacky. An additional 500 g Zn powder was added. No visible dust was observed. Five additional coating layers were applied, as shown in the table below. The eight coating layered particulate composition included 45 kg granulated calcium sulfate (18% calcium and 15% sulfur), 1.68 kg of HD-40 thermo-softening binder, and 5.5 kg WOLF TRAX 62% Zn DDP (6.5% Zn). The method allowed for 10.5 wt % powder incorporation, which was ten times greater than the usage amount recommended by the manufacturer. The particulate composition was substantially dust-free according to the procedures of Example 3 and Example 4.

| | Start Time | Stop Time | Amount | |
|---|---|---|---|---|
| | (s) | (s) | (g) | Comments |
| Mix On | 0 | 392 | | Total Mix 6′32″ |
| Liquid | 1 | 16 | 525 | 35 g/sec spray |
| Powder | 22 | 28 | 500 | No Dust at 50 sec |
| Liquid | 61 | 66 | 175 | |
| Powder | 78 | 83 | 500 | No Dust at 100 sec |
| Liquid | 110 | 115 | 175 | |
| Powder | 130 | 133 | 500 | No Dust at 145 sec |
| Powder | 156 | 160 | 500 | No Dust at 180 sec |
| Liquid | 180 | 185 | 175 | |
| Powder | 190 | 192 | 500 | No Dust at 210 sec |
| Liquid | 215 | 220 | 175 | |
| Powder | 223 | 227 | 500 | No Dust at 240 sec |
| Liquid | 250 | 253 | 105 | |
| Powder | 260 | 265 | 500 | No Dust at 270 sec |
| Powder | 280 | 285 | 500 | No Dust at 300 sec |
| Liquid | 310 | 315 | 175 | |
| Powder | 320 | 325 | 500 | No Dust at 340 sec |
| Liquid | 330 | 335 | 175 | |
| Powder | 340 | 345 | 500 | No Dust at 365 sec |
| Powder | 380 | 385 | 500 | No Dust at 392 sec |
| Total Liquid | | | 1680 | |
| Total Powder | | | 5500 | |

### Example 3: Evaluating Dust—Qualitative Procedure

A vertically-oriented PVC pipe (152.4 cm length; 10.2 cm diameter) was suspended over a metal catch pan. The particulate composition (2 kg) was poured into the PVC pipe and the presence or absence of a dust plume as the particulate composition hit the catch pan was recorded. As used herein, “substantially dust-free” may refer to the absence of a dust plume. The particulate composition described in Examples 1 and 2 did not provide a dust plume.

### Example 4: Evaluating Dust—Quantitative Procedure

On top of a metal pan was stacked a No. 25 USA standard testing sieve (2.36 mm opening; ASTM E-11 Specification) followed by a No. 8 USA standard testing sieve (0.710 mm opening; ASTM E-11 Specification). The particulate composition (500 g) was added to and hand-shaken within the sieve stack assembly for approximately 3 min. The material retained on each of the No. 8 sieve and the No. 25 sieve was weighed. The procedure was conducted a total of four times. As used herein, “substantially dust-free” may refer to less than about 0.5 wt % passing through each of the No. 8 and No. 25 sieves and collected in the pan. The particulate composition described in Examples 1 and 2 provided less than 0.1 wt % dust passing through the sieves.

### Example 5: Evaluating Flowability

Into a plastic funnel (15.3 cm enter diameter; 2.5 cm exit diameter; 30.5 cm height) equipped with a stopper was added 2 kg of particulate composition. The stopper was opened and the particulate composition was allowed to flow out of the funnel. The time required for the particulate composition to exit the funnel was recorded and a flow rate was determined.

### Example 6: Urea/Magnesium Particulate Composition Void of Binder

A binder-less particulate composition of granular urea (Koch Nitrogen Co., Enid, Okla.) and WOLF TRAX 30% Magnesium (Compass Minerals, Overland Park, Kans.) was prepared according to the procedures in U.S. Pat. Nos. 7,410,522 and 7,445,657. WOLF TRAX 30% Magnesium (20 g), which is a powder blend of magnesium sulfate, magnesium oxide, and magnesium carbonate, was applied to granular urea (2 kg) to provide a particulate composition with a powder concentration of 1 wt %. The particulate composition was not determined to be substantially dust-free under the qualitative dust analysis of Example 3. The particulate composition was not determined to substantially dust-free under the quantitate analysis of Example 4: 0.70 wt % was collected from the pan, i.e., about 68% of the powder had become dust.

### Example 7: Urea/Magnesium Particulate Composition Void of Binder

A binder-less particulate composition of granular urea (Koch Nitrogen Co., Enid, Okla.) and WOLF TRAX 30% Magnesium (Compass Minerals, Overland Park, Kans.), was prepared according to the procedures in U.S. Pat. Nos. 7,410,522 and 7,445,657. WOLF TRAX 30% Magnesium (200 g), which is a powder blend of magnesium sulfate, magnesium oxide, and magnesium carbonate, was applied to granular urea (2 kg) to provide a particulate composition with a powder concentration of 10 wt %. The particulate composition was not determined to be substantially dust-free under the qualitative dust analysis of Example 3. The particulate composition was not determined to substantially dust-free under the quantitate analysis of Example 4: 8.80 wt % was collected from the pan, i.e., about 96% of the powder had become dust. The binder particulate composition of Example 1 was substantially dust-free at 10 wt % powder loading, whereas the binder-less particulate composition of Example 7 provided a, product which was largely dust.

### Example 8: Ignimbrite/Zinc Particulate Composition with Vegetable Oil Binder

1500 grams of granular ignimbrite core material (Ignimbrite Minerals, Inc., Bonner Mont.) were added to a trapezoidal mixing drum having a base measurement of about 23 cm, a mouth measurement of about 29 cm, and a height measurement of about 23 cm. The drum was set at a shaft angle of about 40 degrees relative to the direction perpendicular to the force of gravity and rotated at a rate of about 45 RPM. The core materials were at a temperature of about 29° C. The thermos-softening binder, a blend of vegetable oils (Climaguard, Dustech, LLC, Tampa, Fla.), was heated to liquid at about 48° C. on a hot plate (Solid Double Burner Model HP 202-D11, FARBERWARE®, Garden City, N.Y.). The liquefied binder was added to a Husky Siphon Feed Detail Spray Gun Model-H4910DSG (The Home Depot, Atlanta, Ga.). The binder (107 g) was sprayed onto the rotating bed of core materials until the core materials appeared wet and marginally free-flowing. Zinc powder (Wolftrax Zinc DDP powder, 62% zinc powder, Compass Minerals, Overland, Kans.) (30 g) was added to the wet core material. The blend was mixed for 15 seconds. A second charge of binder (19 g) was applied, followed by a second layer of powder (15 g). The blend was mixed for 15 seconds followed by a third application of binder (19 g) and a third application of powder (15 g). After 15 seconds of mix time, a fourth increment of binder (19 g) and a fourth increment of powder (15 g) were added. After 15 seconds of mix time, a fifth increment of binder (25 g) and a fifth increment of powder (22.5 g) were added. After 15 seconds of mix time, a sixth increment of binder (19 g) and a sixth increment of powder (22.5 g) were added. After 15 seconds of mix time, a seventh increment of binder (19 g) and a seventh increment of powder (30 g) were added. In all, a total of seven layers of powder and seven layers of binder were added according to the table below. A total of 227 g of binder and a total of 150 g of powder were applied. This produced a flowable, dust-mitigated particulate composition, containing 60 wt % plant available silica, and 4.9 wt % zinc.

| Core Description | Ignimbrite Granular |
|---|---|
| Core Supplier | Montana Grow |
| Core Weight (grams) | 1500 |
| Core Temperature (F.) | 84 |
| Binder Description | Climaguard |
| Binder Supplier | Dustech LLC |
| Binder Weight (grams) | 227.01 |
| Binder lb/gal | 7.34 |
| Binder Temperature (F.) | 119 |
| Spray Pressure (psi) | 70 |
| Spray Time (sec) | 180 |
| Spray Rates (grams/sec) | 1.26 |
| Powder Description | Wolftrax Zn DDP |
| Powder Source | Compass Minerals |
| Powder Weight (grams) | 150 |
| % ai Powder | 0.62 |
| % ai Product | 4.95% |
| Powder Temperature (F.) | 75 |
| Addition Sequence | |
| Liquid-1 (sec)/(grams) | 85/107 |
| Powder-1 (grams) | 30.0 |
| Mix 1 (sec) | 15 |
| Liquid-2 (sec)/(grams) | 15/19 |
| Powder-2 (grams) | 15.0 |
| Mix 2 (sec) | 15 |
| Liquid-3 (sec)/(grams) | 15/19 |
| Powder-3 (grams) | 15.0 |
| Mix 3 (sec) | 15 |
| Liquid-4 (sec)/(grams) | 15/19 |
| Powder-4 (grams) | 15.0 |
| Mix 4 (sec) | 15 |
| Liquid-5 (sec)/(grams) | 20/25 |
| Powder-5 (grams) | 22.5 |
| Mix 5 (sec) | 15 |
| Liquid-6 (sec)/(grams) | 15/19 |
| Powder-6 (grams) | 22.5 |
| Mix 6 (sec) | 15 |
| Liquid-7 (sec)/(grams) | 15/19 |
| Powder-7 (grams) | 30.0 |
| Mix 7 (sec) | 15 |
| Comments | Product is free flowing and has no dust. |

### Example 9: Ignimbrite/Zinc Particulate Composition with Petroleum Oil Binder

1500 grams of granular ignimbrite core material (Ignimbrite Minerals, Inc., Bonner Mont.) were added to a trapezoidal mixing drum having a base measurement of about 23 cm, a mouth measurement of about 29 cm, and a height measurement of about 23 cm. The drum was set at a shaft angle of about 40 degrees relative to the direction perpendicular to the force of gravity and rotated at a rate of about 45 RPM. The core materials were at a temperature of about 29° C. The thermo-softening binder, a blend of petroleum oils and hydrocarbons (Dustrol 3088, ArrMaz, Mulberry Fla.), was heated to liquid at about 79° C. on a Faberware Solid Double Burner Model HP 202-D11 hot plate. The liquefied binder was added to a Husky Siphon Feed Detail Spray Gun Model-H4910DSG. The binder (46 g) was sprayed onto the rotating bed of core materials until the core materials appeared wet and marginally free-flowing. Wolftrax Zinc DDP powder (37.5 g) was added to the wet core material. The blend was mixed for 15 seconds. A second charge of binder (20 g) was applied, followed by a second layer of powder (37.5 g). The blend was mixed for 15 seconds followed by a third application of binder (19 g) and a third application of powder (45 g). After 15 seconds of mix time, a fourth increment of binder (14 g) and a fourth increment of powder (30 g) were added. In all, a total of four layers of powder and four layers of binder were added according to the table below. A total of 99 g of binder and a total of 150 g of powder were applied. This produced a flowable, dust-mitigated particulate composition, containing 64 wt % plant available silica, and 5.3 wt % zinc.

| Core Description | Ignimbrite Granular |
|---|---|
| Core Supplier | Montana Grow |
| Core Weight (grams) | 1500 |
| Core Temperature (F.) | 77 |
| Binder Description | Dustrol 3088 |
| Binder Supplier | ArrMaz |
| Binder Weight (grams) | 98.89 |
| Binder lb/gal | 8.01 |
| Binder Temperature (F.) | 175 |
| Spray Pressure (psi) | 70 |
| Spray Time (sec) | 75 |
| Spray Rates (grams/sec) | 1.32 |
| Powder Description | Wolftrax Zn DDP |
| Powder Source | Compass Minerals |
| Powder Weight (grams) | 150 |
| % ai Powder | 0.62 |
| % ai Product | 5.32% |
| Powder Temperature (F.) | 75 |
| Addition Sequence | |
| Liquid-1 (sec)/(grams) | 35/46 |
| Powder-1 (grams) | 37.5 |
| Mix 1 (sec) | 15 |
| Liquid-2 (sec)/(grams) | 15/20 |
| Powder-2 (grams) | 37.5 |
| Mix 2 (sec) | 15 |
| Liquid-3 (sec)/(grams) | 15/19 |
| Powder-3 (grams) | 45.0 |
| Mix 3 (sec) | 15 |
| Liquid-4 (sec)/(grams) | 10/14 |
| Powder-4 (grams) | 30.0 |
| Mix 4 (sec) | 15 |
| Comments | Product is free flowing and has no dust. |

### Example 10: Urea/Mg Particulate Composition with HD-605 Binder

Granular urea core material (2 kg) (Koch Nitrogen Co., Enid, Okla.) was added to a trapezoidal mixing drum having a base measurement of about 23 cm, a mouth measurement of about 29 cm, and a height measurement of about 23 cm. The drum was set at a shaft angle of about 40 degrees relative to the direction perpendicular to the force of gravity and rotated at a rate of about 45 RPM. The core materials were at heated to a temperature of about 42° C. HD-60S (Dustech, LLC) binder was heated to about 77° C. on a Faberware Solid Double Burner Model HP 202-D11 hot plate, and added to a Husky Siphon Feed Detail Spray Gun Model-H4910DSG. The binder (18.2 g) was sprayed onto the rotating bed of urea until the core materials appeared wet and marginally free-flowing. WOLF TRAX Mg DDP (30% magnesium powder) (80 g) was added to the wet core material in 20 g increments until the mixture appeared flowable and dusty. The blend was mixed for 25 seconds and then further sprayed with second charge of HD-605. A second charge of powder (40 g) was then applied over 55 seconds. The process was repeated until a total of three layers of binder-powder were added according to the table below. A total of 54.6 g of HD-60S and a total of 200 g of powder were applied.

| Core Description | Urea |
|---|---|
| Core Supplier | Koch Nitrogen |
| Core Weight (grams) | 2000 |
| Core Temperature (F.) | 108 |
| Binder Description | HD-60S |
| Binder Supplier | Dustech LLC |
| Binder Weight (grams) | 54.6 |
| Binder Temperature (F.) | 170 |
| Powder Description | Wolftrax 30% Magnesium |
| Powder Source | Compass Minerals |
| Powder Weight (grams) | 200 |
| Powder Temperature (F.) | 69 |
| Addition Sequence: | |
| Binder | 18.2/2 |
| Powder | 80/125 |
| Mix | 25 |
| Binder | 18.2/2 |
| Powder | 40/55 |
| Mix | 5 |
| Binder | 18.2/2 |
| Powder | 80/30 |
| Mix | 60 |

### Example 11: Urea/Mg Particulate Composition with HD-60 Binder

Granular urea core material (2 kg) (Koch Nitrogen Co., Enid, Okla.) was added to a trapezoidal mixing drum having a base measurement of about 23 cm, a mouth measurement of about 29 cm, and a height measurement of about 23 cm. The drum was set at a shaft angle of about 40 degrees relative to the direction perpendicular to the force of gravity and rotated at a rate of about 45 RPM. The core materials were at heated to a temperature of about 76° C. HD-60 (Dustech, LLC) binder was heated to about 109° C. on a Faberware Solid Double Burner Model HP 202-D11 hot plate, and added to a Husky Siphon Feed Detail Spray Gun Model-H4910DSG. The binder (50 g) was sprayed onto the rotating bed of urea until the core materials appeared wet and marginally free-flowing. WOLF TRAX Mg DDP (30% magnesium powder) (40 g) was added to the wet core material in 20 g increments over a period of 34 seconds. The blend was mixed for 26 seconds and an additional charge of powder (20 g) was added until the mixture appeared flowable and dusty. A second charge of binder (25 g) was applied, followed by a second layer of powder (60 g). The process was repeated until a total of three layers of binder-powder were added according to the table below. A total of 112.6 g of HD-60 and a total of 200 g of powder were applied.

| Core Description | Urea |
|---|---|
| Core Supplier | Koch Nitrogen |
| Core Weight (grams) | 2000 |
| Core Temperature (F.) | 169 |
| Binder Description | HD-60 |
| Binder Supplier | Dustech LLC |
| Binder Weight (grams) | 112.6 |
| Binder Temperature (F.) | 229 |
| Powder Description | Wolftrax 30% Magnesium |
| Powder Source | Compass Minerals |
| Powder Weight (grams) | 200 |
| Powder Temperature (F.) | 72 |
| Addition Sequence: | grams/sec |
| Binder | 50/20 |
| Powder | 40/34 |
| Mix | 26 |
| Binder | |
| Powder | 20/15 |
| Mix | 60 |
| Binder | 25/10 |
| Powder | 60/60 |
| Mix | 60 |
| Binder | 37.5/15 |
| Powder | 80/60 |
| Mix | 231 |

### Example 12: CaSO₄/ZnO Particulate Composition with HD-40 Binder

A High Intensity Mixer (HIM) by A. J. Sackett & Sons Company was charged with calcium sulfate (45 kg) (Charah Agricultural Products, Louisville, Ky.). The core materials were at a temperature of about 5° C. HD-40 (Dustech, LLC) binder was heated to about 85° C. to provide a thin, flowable liquid. The liquefied thermo-softening binder (178 g) was sprayed onto the surface of the core material using a Spray Systems 9508 nozzle at a spray pressure of 5 psig for 4 s (45 g/s rate). The binder (178 g) was sprayed onto the rotating bed of calcium sulfate for a period of 4 seconds until the core materials appeared wet and marginally free-flowing. Zinc oxide (579 g) was added to the wet core material and the blend was allowed to mix for a period of 11 seconds. A second charge of binder (222 g) was applied over a period of 5 seconds, followed by a second charge of powder (384 g). An additional charge of powder (193 g) was added until the blend appeared dusty. The process was repeated until a total of three layers of binder-powder were added according to the table below. A total of 712 g of HD-40 and a total of 1350 g of powder were applied.

| Core Description | Synthetic Calcium Sulfate |
|---|---|
| Core Supplier | Charah Agricultural Products |
| Core Weight (lbs) | 100 |
| Core Temperature (F.) | 42 |
| Binder Description | HD-40 |
| Binder Supplier | Dustech LLC |
| Binder Weight (grams) | 712 |
| Binder Temperature (F.) | 185 |
| Powder Description | Zn Oxide (72% Zn) |
| Powder Source | Prince Minerals |
| Powder Weight (grams) | 1350 |
| Powder Temperature (F.) | 65 |
| Addition Sequence: | grams/sec |
| Binder | 178/4 |
| Powder | 579 |
| Mix | 11 |
| Binder | 222/5 |
| Powder | 386/4 |
| Mix | 10 |
| Binder | |
| Powder | 193/2 |
| Mix | 13 |
| Binder | 311/7 |
| Powder | 193/2 |
| Mix | 56 |

### Example 13: CaSO₄/Fe₃O₄ Particulate Composition with HD-40 Binder

A High Intensity Mixer (HIM) by A. J. Sackett & Sons Company was charged with calcium sulfate (45 kg) (Charah Agricultural Products, Louisville, Ky.). The core materials were at a temperature of about 16° C. HD-40 (Dustech, LLC) binder was heated to about 86° C. to provide a thin, flowable liquid. The liquefied thermo-softening binder (245 g) was sprayed onto the surface of the core material using a Spray Systems 9508 nozzle at a spray pressure of 5 psig for 5 s (49 g/s rate). The binder (245 g) was sprayed onto the rotating bed of calcium sulfate for a period of 5 seconds until the core materials appeared wet and marginally free-flowing. Iron oxide magnetite (816 g) was added to the wet core material over a period of 6 seconds, and the blend was allowed to mix for a period of 9 seconds. A second charge of binder (246 g) was applied over a period of 5 seconds, followed by a second charge of powder (544 g). An outermost binder layer (246 g) was then applied. A total of 737 g of HD-40 and a total of 1360 g of powder were applied.

| Core Description | Synthetic Calcium Sulfate |
|---|---|
| Core Supplier | Charah Agricultural Products |
| Core Weight (lbs) | 100 |
| Core Temperature (F.) | 61 |
| Binder Description | HD-40 |
| Binder Supplier | Dustech LLC |
| Binder Weight (grams) | 737 |
| Binder Temperature (F.) | 186 |
| Powder Description | Fe Oxide Magnetite (79% Fe) |
| Powder Source | Prince Minerals |
| Powder Weight (grams) | 1360 |
| Powder Temperature (F.) | 61 |
| Addition Sequence: | grams/sec |
| Binder | 245/5 |
| Powder | 816/6 |
| Mix | 9 |
| Binder | 246/5 |
| Powder | 544/4 |
| Mix | 20 |
| Binder | 246/5 |
| Powder | |
| Mix | 50 |

### Example 14: CaSO₄/MnO Particulate Composition with HD-40 Binder

A High Intensity Mixer (HIM) by A. J. Sackett & Sons Company was charged with calcium sulfate (45 kg) (Charah Agricultural Products, Louisville, Ky.). The core materials were at a temperature of about 19° C. HD-40 (Dustech, LLC) binder was heated to about 88° C. to provide a thin, flowable liquid. The liquefied thermo-softening binder (258 g) was sprayed onto the surface of the core material using a Spray Systems 9508 nozzle at a spray pressure of 5 psig for 5 s (52 g/s rate). The binder (258 g) was sprayed onto the rotating bed of calcium sulfate for a period of 5 seconds until the core materials appeared wet and marginally free-flowing. Manganese oxide (1240 g) was added to the wet core material over a period of 4 seconds, and the blend was allowed to mix for a period of 14 seconds. A second charge of binder (257 g) was applied over a period of 5 seconds, followed by a second charge of powder (1240 g). The process was repeated for a total of three binder-powder layers as described in the table below. A total of 773 g of HD-40 and a total of 3100 g of powder were applied.

| Core Description | Synthetic Calcium Sulfate |
|---|---|
| Core Supplier | Charah Agricultural Products |
| Core Weight (lbs) | 100 |
| Core Temperature (F.) | 66 |
| Binder Description | HD-40 |
| Binder Supplier | Dustech LLC |
| Binder Weight (grams) | 773 |
| Binder Temperature (F.) | 190 |
| Powder Description | Mn Oxide (60% Mn) |
| Powder Source | Prince Minerals |
| Powder Weight (grams) | 3100 |
| Powder Temperature (F.) | 65 |
| Addition Sequence: | |
| Binder | 258/5 |
| Powder | 1240/4 |
| Mix | 14 |
| Binder | 257/5 |
| Powder | 1240/4 |
| Mix | 15 |
| Binder | |
| Powder | 620/2 |
| Mix | 25 |

### Example 15: CaSO₄/Urea-Formaldehyde Particulate Composition with HD-40 Binder

A High Intensity Mixer (HIM) by A. J. Sackett & Sons Company was charged with calcium sulfate (45 kg) (Charah Agricultural Products, Louisville, Ky.). The core materials were at a temperature of about 16° C. HD-40 (Dustech, LLC) binder was heated to about 88° C. to provide a thin, flowable liquid. The liquefied thermo-softening binder (424 g) was sprayed onto the surface of the core material using a Spray Systems 9508 nozzle at a spray pressure of 5 psig for 10 s (42 g/s rate). The binder (424 g) was sprayed onto the rotating bed of calcium sulfate for a period of 10 seconds until the core materials appeared wet and marginally free-flowing. NITROFORM® (Koch Turf and Ornamental, Wichita, Kans.) (500 g), a urea-formaldehyde resin, was added to the wet core material over a period of 5 seconds, and the blend was allowed to mix for a period of 10 seconds. Three additional powder charges (500 g ea.) were added until the blend appeared dusty. A second charge of binder (212 g) was applied over a period of 5 seconds, followed by two charges of powder (500 g ea). The process was repeated for a total of five binder-powder layers as described in the table below. A total of 1483 g of HD-40 and a total of 8000 g of powder were applied.

| Core Description | Synthetic Calcium Sulfate |
|---|---|
| Core Supplier | Charah Agricultural Products |
| Core Weight (lbs) | 100 |
| Core Temperature (F.) | 60 |
| Binder Description | HD-40 |
| Binder Supplier | Dustech LLC |
| Binder Weight (grams) | 1483 |
| Binder Temperature (F.) | 190 |
| Powder Description | Nitroform Powder (39% N) |
| Powder Source | Koch Turf and Ornamental |
| Powder Weight (grams) | 8000 |
| Powder Temperature (F.) | 62 |
| Addition Sequence: | |
| Binder | 424/10 |
| Powder | 500/5 |
| Mix | 10 |
| Binder | |
| Powder | 500/5 |
| Mix | 14 |
| Binder | |
| Powder | 500/5 |
| Mix | 16 |
| Binder | |
| Powder | 500/3 |
| Mix | 23 |
| Binder | 212/5 |
| Powder | 500/4 |
| Mix | 14 |
| Binder | |
| Powder | 500/4 |
| Mix | 21 |
| Binder | 212/5 |
| Powder | 500/3 |
| Mix | 15 |
| Binder | |
| Powder | 500/3 |
| Mix | 9 |
| Binder | 212/5 |
| Powder | 500/3 |
| Mix | 12 |
| Binder | |
| Powder | 500/3 |
| Mix | 9 |
| Binder | 424/10 |
| Powder | 500/4 |
| Mix | 13 |
| Binder | |
| Powder | 500/3 |
| Mix | 32 |
| Binder | |
| Powder | 500/4 |
| Mix | 15 |
| Binder | |
| Powder | 500/5 |
| Mix | 26 |
| Binder | |
| Powder | 500/4 |
| Mix | 11 |
| Binder | |
| Powder | 500/4 |
| Mix | 26 |

### Example 16: Ammonium Sulfate/Zinc Particulate Composition with HD-40 Binder

Granular ammonium sulfate core material (1 kg) (Honeywell Specialty Materials, Hopewell Va.) was added to a trapezoidal mixing drum having a base measurement of about 23 cm, a mouth measurement of about 29 cm, and a height measurement of about 23 cm. The drum was set at a shaft angle of about 40 degrees relative to the direction perpendicular to the force of gravity and rotated at a rate of about 45 RPM. The core materials were at a temperature of about 24° C. A vegetable oil based thermo-softening binder (HD-40, Dustech, LLC, Tampa Fla.) was heated to about 81° C. on a Faberware Solid Double Burner Model HP 202-D11 hot plate, and added to a Husky Siphon Feed Detail Spray Gun Model-H4910DSG. The binder (17 g) was sprayed onto the rotating bed of core materials until the core materials appeared wet and marginally free-flowing. Zinc Sulfate powder (35.5% zinc powder) (17 g) (Prince Minerals, Houston, Tex.) was added to the wet core material. The blend was mixed for 15 seconds. A second charge of binder (8 g) was applied, followed by a second layer of powder (18 g). The blend was mixed for 15 seconds followed by a third application of binder (9 g) and a third application of powder (17 g). After 15 seconds of mix time, a fourth increment of binder (9 g) and a fourth increment of powder (13 g) were added. After 15 seconds of mix time, a fifth increment of binder (22 g) was added. In all, a total of four layers of powder and five layers of binder were added according to the table below. A total of 31.6 g of binder and a total of 65 g of powder were applied. This produced a flowable, dust-mitigated particulate composition, containing 19 wt % nitrogen, 22 wt % sulfur and 2.1 wt % zinc.

| Core Description | Granular Ammonium Sulfate |
|---|---|
| Core Supplier | Honeywell Specialty Materials |
| Core Weight (grams) | 1000 |
| Core Temperature (F.) | 75 |
| Binder Description | HD-40 |
| Binder Supplier | Dustech LLC |
| Binder Weight (grams) | 31.63 |
| Binder lb/gal | 8.01 |
| Binder Temperature (F.) | 178 |
| Spray Pressure (psi) | 50 |
| Spray Time (sec) | 115 |
| Spray Rates (grams/sec) | 0.28 |
| Powder Description | Zn Sulfate |
| Powder Source | Prince Minerals |
| Powder Weight (grams) | 65 |
| % ai Powder | 0.355 |
| % ai Product | 2.10% |
| Powder Temperature (F.) | 67 |
| Addition Sequence | |
| Liquid-1 (sec)/(grams) | 30/17 |
| Powder-1 (grams) | 17 |
| Mix 1 (sec) | 15 |
| Liquid-2 (sec)/(grams) | 15/8 |
| Powder-2 (grams) | 18 |
| Mix 2 (sec) | 15 |
| Liquid-3 (sec)/(grams) | 15/9 |
| Powder-3 (grams) | 17 |
| Mix 3 (sec) | 15 |
| Liquid-4 (sec)/(grams) | 15/9 |
| Powder-4 (grams) | 13 |
| Mix 4 (sec) | 15 |
| Liquid-5 (sec)/(grams) | 40/22 |
| Powder-5 (grams) | |
| Mix 5 (sec) | 15 |
| Comments | Product is free flowing and has no dust. |

### Example 17: (Prophetic) Ammonium Sulfate/Zinc Particulate Composition with Vegetable Oil Binder, Produced in a Continuous Process

Granular ammonium sulfate core material (Honeywell Specialty Materials, Hopewell Va.) is metered via a Ranco Series II declining weight system (Ranco Fertiservice Inc., Sioux Rapids, Iowa) into a Ranco 24′×12″ Blend Auger at a rate of 5 tons per hour. The core materials are at a temperature of about 25° C. A vegetable oil based binder (HD-40, Dustech, LLC, Tampa, Fla.) is heated to about 80° C. by pumping through an electric heat exchanger. The liquefied binder is pumped to the mixing auger at a metered rate of 5.26 pounds per minute through six Spray Systems UniJet #11001 nozzles located at 2, 4, 8, 12, 14, 18, 22 feet from the inlet of the mixer. Zinc Sulfate powder (35.5% zinc powder) (Prince Minerals, Houston, Tex.) is metered into the mixer at four locations (6, 10, 16, 20 feet from the inlet of the mixer) at rate of 2.7 pound per minute at each location for a total powder feed rate of 10.8 pounds per minute. This produces a flowable, dust-mitigated particulate composition, containing 19 wt % nitrogen, 22 wt % sulfur and 2.1 wt % zinc.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Gamer, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. To the extent that the term “substantially” is used in the specification or the claims, it is intended to mean that the identified components have the relation or qualities indicated with degree of error as would be acceptable in the subject industry.

As used in the specification and the claims, the singular forms “a,” “an,” and “the” include the plural unless the singular is expressly specified. For example, reference to “a compound” may include a mixture of two or more compounds, as well as a single compound.

As used herein, the term “about” in conjunction with a number is intended to include ±10% of the number. In other words, “about 10” may mean from 9 to 11.

As used herein, the terms “optional” and “optionally” mean that the subsequently described circumstance may or may not occur, so that the description includes instances where the circumstance occurs and instances where it does not.

In addition, where features or aspects of the disclosure are described in terms of Markush groups, those skilled in the art will recognize that the disclosure is also thereby described in terms of any individual member or subgroup of members of the Markush group. As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, and the like. As a non-limiting example, each range discussed herein can be readily broken down into a lower third, middle third and upper third, and the like. As will also be understood by one skilled in the art all language such as “up to,” “at least,” “greater than,” “less than,” include the number recited and refer to ranges which can be subsequently broken down into sub-ranges as discussed above. Finally, as will be understood by one skilled in the art, a range includes each individual member. For example, a group having 1-3 cells refers to groups having 1, 2, or 3 cells. Similarly, a group having 1-5 cells refers to groups having 1, 2, 3, 4, or 5 cells, and so forth. While various aspects and embodiments have been disclosed herein, other aspects and embodiments will be apparent to those skilled in the art.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

The various aspects and embodiments disclosed herein are for purposes of illustration and are not intended to be limiting, with the true scope and spirit being indicated by the following claims.

1-96. (canceled)

97. A particulate composition, comprising:
a particle, comprising:
(A) a core comprising a nutrient, the nutrient comprising one or more of sulfur, nitrogen, potassium, and phosphorus; and
(B) separate coating layers disposed about the core, wherein the separate coating layers comprise:
(1) a thermo-softening binder layer that coats over the core, the thermo-softening binder layer comprising a mixture of fatty acids and rosin acids; and
(2) a separate powder layer that adheres to the thermo-softening binder layer, the powder layer comprising one or more of: boron, chlorine, fluorine, iodine, copper, iron, manganese, molybdenum, nickel, zinc, cobalt, magnesium, chromium, calcium, sodium, selenium, and silicon,
wherein the core is about 75 to about 99 wt % of the particulate composition, the powder is present in an amount about 1 wt % to about 15 wt % of the particulate composition, and the particulate composition is substantially dust-free.

98. The particulate composition of claim 97, wherein the particle is characterized by a Size Guide Number (SGN) greater than about 80 and a Uniformity Index (UI) greater than about 30, and the powder is characterized by a SGN number of less than about 20.

99. The particulate composition of claim 97, wherein the particle comprises a binder_{(N)}-[powder-binder]_{(M)}-core, wherein N is 0 or 1, and M is an integer from 1 to 10, and wherein the amount of the thermo-softening binder layer is about 0.5 to about 5 wt % of the particulate composition.

100. The particulate composition of claim 97, wherein the thermo-softening binder layer is characterized by:
a tack value determined at a temperature of 25° C. according to ASTM D2979 of between about 1 mN and about 50 mN; and
a viscosity at a temperature of 100° C. and at atmospheric pressure of between about 15 and about 50000 centiPoise (cP).

101. The particulate composition of claim 97, comprising a core:powder ratio of about 85:15 to about 99:1 by weight or a thermo-softening binder layer:powder ratio of about 1:1 to about 1:5 by weight.

102. The particulate composition of claim 97, comprising at least part of the thermo-softening binder layer and the powder layer in the form of a matrix or at least part of the powder layer in the form of an adhered powder.

103. A method for producing a substantially dust-free particulate composition, the method comprising:
(A) providing a plurality of cores, wherein each core comprises a nutrient comprising one or more of sulfur, nitrogen, potassium, and phosphorus;
(B) heating a thermo-softening binder layer to a temperature effective to liquefy the thermo-softening binder layer to provide a liquefied thermo-softening binder layer, wherein the thermo-softening binder layer comprises a mixture of fatty acids and rosin acids;
(C) forming one or more separate coating layers disposed about each core, the forming comprising:
(1) contacting each core with the liquefied thermo-softening binder layer to form a binder layer that coats over the core;
(2) contacting over each binder layer with a powder layer to provide a separate powder-binder-multi-layer disposed over each core, wherein the powder layer comprises one or more of: boron, chlorine, fluorine, iodine, copper, iron, manganese, molybdenum, nickel, zinc, cobalt, magnesium, chromium, calcium, sodium, selenium, and silicon, and wherein the powder layer is present in an amount about 1 wt % to about 15 wt % of the particulate composition; and
(3) cooling the powder-binder-multi-layer to solidify the liquefied thermo-softening binder layer effective to bind the powder layer to the binder layer to form each coating layer, thereby forming the flowable, dust-mitigated particulate composition as a plurality of the cores comprising the one or more coating layers disposed about each core.

104. The method of claim 103, wherein the heating the thermo-softening binder layer comprises heating the thermo-softening binder layer to a temperature effective to reach a viscosity of less than about 500 cP.

105. The method of claim 103, wherein the forming the one or more coating layers comprises contacting an amount of the liquefied thermo-softening binder layer in weight % with respect to an amount of the plurality of cores about 0.02 to about 2.0.

106. The method of claim 103, comprising forming at least two coating layers disposed about each core, the at least two coating layers comprise at least two powder-binder-multi-layers.

107. The method of claim 103, wherein forming each coating layer comprises contacting each core with the liquefied thermo-softening binder layer to provide the binder layer and contacting each binder layer with the powder layer to provide each binder-powder-multi-layer, and wherein forming the one or more coating layers comprises contacting each binder-powder-multi-layer with the liquefied thermo-softening binder layer to provide a binder_{(N)}-[powder-binder]_{(M)}-core, wherein N is 0 or 1, and M is an integer from 1 to 10.

108. The method of claim 103, wherein the method is conducted as a batch process or as a continuous process.
